(19) United States
(12) Patent Application Publication
(10) Pub. No.: US 2011/0123735 A1
(43) Pub. Date: May 26, 2011

(54) CNT-INFUSED FIBERS IN THERMOSET MATRICES

(75) Inventors: Tushar K. SHAH, Columbia, MD (US); Harry C. Malecki, Abingdon, MD (US); Samuel J. Markkula, Rising Sun, MD (US); Mark R. Alberding, Glen Arm, MD (US)

(73) Assignee: APPLIED NANOSTRUCTURED SOLUTIONS, LLC, Baltimore, MD (US)

(21) Appl. No.: 12/952,144

(22) Filed: Nov. 22, 2010

Related U.S. Application Data
(60) Provisional application No. 61/263,806, filed on Nov. 23, 2009.

(51) Int. Cl. B32B 1/08; B32B 37/02; B32B 37/14; B32B 38/00; B32B 5/02; C08K 3/04; B82Y 99/00; B82Y 40/00; B82Y 30/00

(52) U.S. Cl. 428/34.1; 156/190; 428/221; 523/468; 977/751; 977/752; 977/843; 977/902

(57) ABSTRACT

A structural support includes a cylindrical core, an inner layer within the core and an outer layer. The inner and outer layers include CNT-infused fiber materials in a thermoset matrix. A composite includes a thermoset matrix and a CNT-infused fiber material having CNTs with lengths between about 20 to about 500 microns or about 0.1 to about 15 microns. For the latter range, CNTs are present between about 0.1 to about 5 percent by weight of the composite. A method of making a structural support includes wet winding a first CNT-infused fiber about a cylindrical mandrel in a direction substantially parallel to the mandrel axis, wet winding a baseline layer about the first CNT-infused fiber at an angle substantially non-parallel to the mandrel axis, and wet winding a second CNT-infused fiber about the baseline layer in a direction substantially parallel to the mandrel axis.

### STATEMENT OF RELATED APPLICATIONS

This application claims priority under 35 U.S.C. 119(e) to U.S. Provisional Application 61/263,806 filed Nov. 23, 2009.

### STATEMENT REGARDING FEDERALLY SPONSORED RESEARCH OR DEVELOPMENT

Not applicable.

### BACKGROUND AND FIELD OF THE INVENTION

The present invention generally relates to carbon nanotubes (CNTs), and more specifically to CNTs incorporated in composite materials.

Nanocomposites have been studied extensively over the past several years. Efforts have been made to modify the matrix properties by mixing in various nanoparticle materials. CNTs, in particular, have been used as a nanoscale reinforcement material but full scale production potential has not been realized due to the complexity of their incorporation in matrix materials, such as large increases in viscosity with CNT loading.

New composites materials that take advantage of nanoscale materials to enhance composite properties along with processes to access these composites would be beneficial. The present invention satisfies this need and provides related advantages as well.

### SUMMARY OF THE INVENTION

In some aspects, embodiments disclosed herein relate to a structural support that includes a cylindrical structural core, an inner layer disposed concentrically within the core, the inner layer including a first CNT-infused fiber material in a first thermoset matrix, and an outer layer that includes a second CNT-infused fiber material in a second thermoset matrix.

In some aspects, embodiments disclosed herein relate to a composite that includes a thermoset matrix and a CNT-infused fiber material having CNTs with lengths between about 20 microns to about 500 microns.

In some aspects, embodiments disclosed herein relate to a composite that includes a CNT-infused fiber material having CNTs ranging in length from between about 0.1 microns to about 20 microns, and a thermoset matrix. The CNTs are present in a range from between about 0.1 percent by weight to about 5 percent by weight of the composite.

In some aspects, embodiments disclosed herein relate to a method of making a structural support that includes wet winding a first CNT-infused fiber about a cylindrical mandrel in a direction substantially parallel to the mandrel axis, wet winding a baseline layer about the wound first CNT-infused fiber at an angle substantially non-parallel to the mandrel axis, and, wet winding a second CNT-infused fiber about the baseline layer in a direction substantially parallel to the mandrel axis. Each wet winding step comprises wet winding with at least one thermoset matrix.

### BRIEF DESCRIPTION OF THE DRAWINGS

FIG. 1 shows a transmission electron microscope (TEM) image of a multi-walled CNT (MWNT) grown on AS4 carbon fiber via a continuous CVD process.

FIG. 2 shows a TEM image of a double-walled CNT (DWNT) grown on AS4 carbon fiber via a continuous CVD process.

FIG. 3 shows a scanning electron microscope (SEM) image of CNTs growing from within the barrier coating where the CNT-forming nanoparticle catalyst was mechanically infused to the carbon fiber material surface.

FIG. 4 shows a SEM image demonstrating the consistency in length distribution of CNTs grown on a carbon fiber material to within 20% of a targeted length of about 40 microns.

FIG. 5 shows an SEM image demonstrating the effect of a barrier coating on CNT growth. Dense, well aligned CNTs grew where barrier coating was applied and no CNTs grew where barrier coating was absent.

FIG. 6 shows a low magnification SEM of CNTs on carbon fiber demonstrating the uniformity of CNT density across the fibers within about 10%.

FIG. 7 shows a process for producing CNT-infused carbon fiber material in accordance with the illustrative embodiment of the present invention.

FIG. 8 shows how a carbon fiber material can be infused with CNTs in a continuous process to target thermal and electrical conductivity improvements.

FIG. 9 shows how carbon fiber material can be infused with CNTs in a continuous process using a “reverse” barrier coating process to target improvements in mechanical properties, especially interfacial characteristics such as shear strength.

FIG. 10 shows the effect of infused CNTs on IM7 carbon fiber on interlaminar fracture toughness. The baseline material is an unsized IM7 carbon fiber, while the CNT-Infused material is an unsized carbon fiber with 15 micron long CNTs infused on the fiber surface.

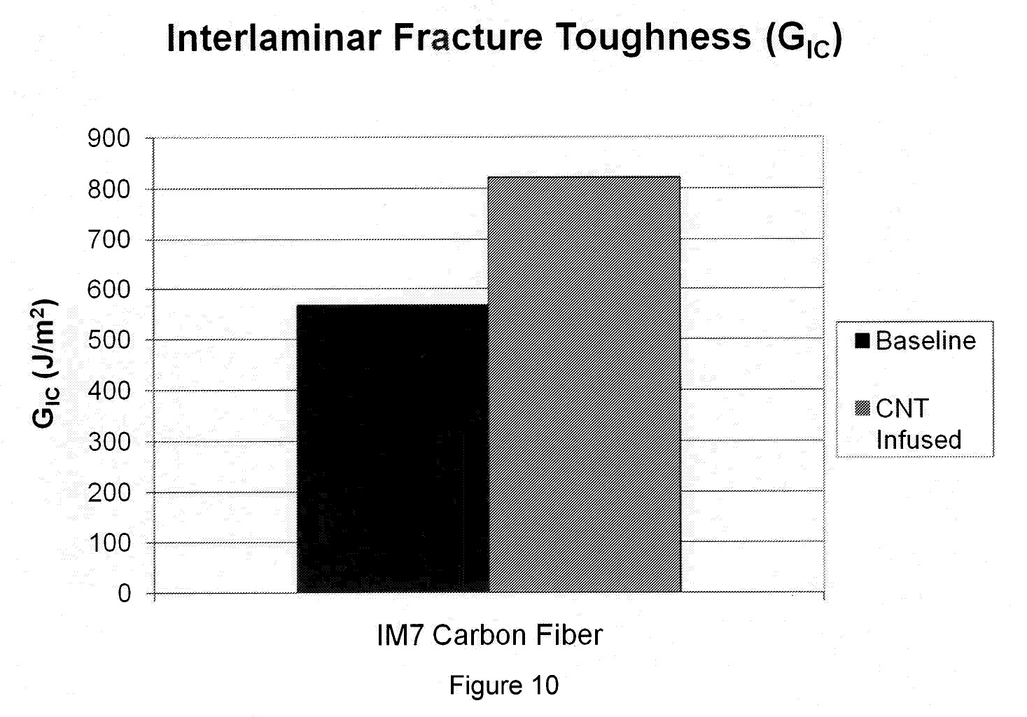

FIG. 11 shows the effect of CNT percent on fiber on fiber volume percent on S-glass fibers.

FIG. 12 shows a structural support, in accordance with some embodiments of the invention.

The present invention provides a composite that includes a thermoset matrix material and a carbon nanotube (CNT)-infused fiber material dispersed through at least a portion of the thermoset matrix material. Composite structures made with thermoset matrices can be made without the need for additional processing for CNT dispersion. Additional benefits stem from the ability to control the CNT orientation, including circumferentially perpendicular or parallel to the fiber surface. The length of the CNTs can also be controlled along with the overall loading percentage.

Any composite structure which can be created with glass or carbon fibers using conventional manufacturing techniques involving thermoset matrices can be created with CNT infused fibers without any additional processing steps. These multiscale composites can show increased mechanical properties in addition to amplifying thermal and electrical conductivity.

Applications for fibrous composite materials are increasing rapidly with a variety of demands on structural, thermal and electrical properties, for example. One subset of composite materials is fiber-reinforced thermoset matrix composites. These composite materials can be created with glass and carbon fibers, as well as ceramic, metal, and organic fibers, which are integrated with an uncured thermoset matrix using a variety of techniques and cured through a thermal cycle. Predominantly microscale reinforcement is used with glass or carbon fibers with diameters on the order of 5-15 microns. To enhance the mechanical, thermal and electrical properties of a fibrous composite, composites of the invention incorporate CNT-infused fibers as described further below.

These CNT modified fibers are incorporated into a thermoset matrix through various techniques, including but not limited to chopped fiber layup, resin transfer molding and wet winding, vacuum assisted resin transfer molding (VARTM), and prepreg manufacture. Any current technique which is used to incorporate glass or carbon fiber for use as a composite structure can be used for the incorporation of CNT infused fibers. Any thermoset matrix can be utilized including the industry standard epoxy and polyester family groups, in addition to phenolics, silicones, polyimides, and the like. Polyester resin can be used, for example, for the creation of bulk-molding compound (BMC) or sheet molding compound (SMC) which incorporate chopped or continuous fibers, pre-mixed with the resin. CNT infused fibers can be incorporated into BMC or SMC, providing a multi-length scale reinforcement which can be utilized in a composite structure previously created with non-CNT BMC or SMC.

Fibers can be infused with CNTs up to a CNT loading percent of about 40% by weight. The amount of CNT infusion can be controlled with precision to tailor the CNT loading to a custom application depending on the desired properties. For increased thermal and electrical conductivity, more CNTs can be used, for example. The CNT enhanced composite structure includes a primary reinforcement by the base fiber, a thermoset polymer as the matrix and CNTs as nanoscale reinforcement bound to the base fiber. The fiber volume of the composite can be in a range from as low as about 10% to about 75%, resin volume from about 25 to about 85%, and the CNT volume percent can range up to about 35%.

In classical composites, it is typical to have a about 60% fiber to about 40% matrix ratio, however the introduction of a third element, that is the infused CNTs, allows these ratios to be altered. For example, with the addition of up to about 25% CNTs by volume, the fiber portion can vary between about 10% to about 75% with the matrix range changing to about 25% to about 85%. The various ratios can alter the properties of the overall composite, which can be tailored to target one or more desired characteristics. The properties of CNTs lend themselves to fibers that are reinforced with them. Utilizing these enhanced fibers in thermoset composites similarly imparts increases that will vary according to the fiber fraction, but can still greatly alter the properties of thermoset composites compared to those know in the art.

As used herein the term “fiber material” refers to any material which has fiber as its elementary structural component. Fibers materials can include glass, carbon, ceramic, metal, aramid, and other organic fibers, both natural and synthetic. The term encompasses fibers, filaments, yarns, tows, tows, tapes, woven and non-woven fabrics, plies, mats, and the like.

As used herein the term “spoolable dimensions” refers to fiber materials having at least one dimension that is not limited in length, allowing for the material to be stored on a spool or mandrel. Fiber materials of “spoolable dimensions” have at least one dimension that indicates the use of either batch or continuous processing for CNT infusion as described herein. One exemplary fiber material of spoolable dimensions that is commercially available is exemplified by AS4 12 k carbon fiber tow with a tex value of 800 (1 tex=1 g/1,000 m) or 620 yard/lb (Grafil, Inc., Sacramento, Calif.). Commercial carbon fiber tow, in particular, can be obtained in 5, 10, 20, 50, and 100 lb. (for spools having high weight, usually a 3 k/12K tow) spools, for example, although larger spools may require special order. Processes of the invention operate readily with 5 to 20 lb. spools, although larger spools are usable. Moreover, a pre-process operation can be incorporated that divides very large spoolable lengths, for example 100 lb. or more, into easy to handle dimensions, such as two 50 lb spools.

As used herein, the term “carbon nanotube” (CNT, plural CNTs) refers to any of a number of cylindrically-shaped allotropes of carbon of the fullerene family including single-walled carbon nanotubes (SWNTs), double-walled carbon nanotubes (DWNTs), multi-walled carbon nanotubes (MWNTs). CNTs can be capped by a fullerene-like structure or open-ended. CNTs include those that encapsulate other materials.

As used herein “uniform in length” refers to length of CNTs grown in a reactor. “Uniform length” means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length.

As used herein “uniform in distribution” refers to the consistency of density of CNTs on a fiber material. “Uniform distribution” means that the CNTs have a density on the fiber material with tolerances of plus or minus about 10% coverage defined as the percentage of the surface area of the fiber covered by CNTs. This is equivalent to ±1500 CNTs/μm² for an 8 nm diameter CNT with 5 walls. Such a figure assumes the space inside the CNTs as fillable.

As used herein, the term “infused” means bonded and “infusion” means the process of bonding. Such bonding can involve direct covalent bonding, ionic bonding, pi-pi, and/or van der Waals force-mediated physisorption. For example, the CNTs can be directly bonded to the fiber carrier covalently. Bonding can be indirect, such as CNT infusion to a fiber via a passivating barrier coating and/or an intervening transition metal nanoparticle disposed between the CNT and the fiber. In the CNT-infused fibers disclosed herein, the carbon nanotubes can be “infused” to the fiber directly or indirectly as described above. The particular manner in which a CNT is “infused” to a fiber materials is referred to as a “bonding motif” Regardless of the actual bonding motif of the CNT-infused fiber, the infusion process described herein provides a more robust bonding than simply applying loose, pre-fabricated CNTs to a fiber. In this respect, the synthesis of CNTs on catalyst-laden fiber substrates provides “infusion” that is stronger than van der Waals adhesion alone. CNT-infused fibers made by the processes described herein further below can provide a network of highly entangled branched carbon nanotubes which can exhibit a shared-wall motif between neighboring CNTs, especially at higher densities. In some embodiments, growth can be influenced, for example, in the presence of an electric field to provide alternative growth morphologies. The growth morphology at lower densities can also deviate from a branched shared-wall motif, while still providing strong infusion to the fiber.

As used herein, the term “transition metal” refers to any element or alloy of elements in the d-block of the periodic table. The term “transition metal” also includes salt forms of the base transition metal element such as oxides, carbides, nitrides, and the like.

As used herein, the term “nanoparticle” or NP (plural NPs), or grammatical equivalents thereof refers to particles sized between about 0.1 to about 100 nanometers in equivalent spherical diameter, although the NPs need not be spherical in shape. Transition metal NPs, in particular, serve as catalysts for CNT growth on the fiber materials.

As used herein, the term “sizing agent,” “fiber sizing agent,” or just “sizing,” refers collectively to materials used in the manufacture of fibers as a coating to protect the integrity of the fibers, provide enhanced interfacial interactions between a fiber and a matrix material in a composite, and/or alter and/or enhance particular physical properties of a fiber. In some embodiments, CNTs infused to fiber materials behave as a sizing agent.

As used herein, the term “matrix material” refers to a bulk material than can serve to organize sized CNT-infused fiber materials in particular orientations, including random orientation. The matrix material can benefit from the presence of the CNT-infused fiber material by imparting some aspects of the physical and/or chemical properties of the CNT-infused fiber material to the matrix material.

As used herein, the term “material residence time” refers to the amount of time a discrete point along a fiber material of spoolable dimensions is exposed to CNT growth conditions during the CNT infusion processes described herein. This definition includes the residence time when employing multiple CNT growth chambers.

As used herein, the term “linespeed” refers to the speed at which a fiber material of spoolable dimensions can be fed through the CNT infusion processes described herein, where linespeed is a velocity determined by dividing CNT chamber(s) length by the material residence time.

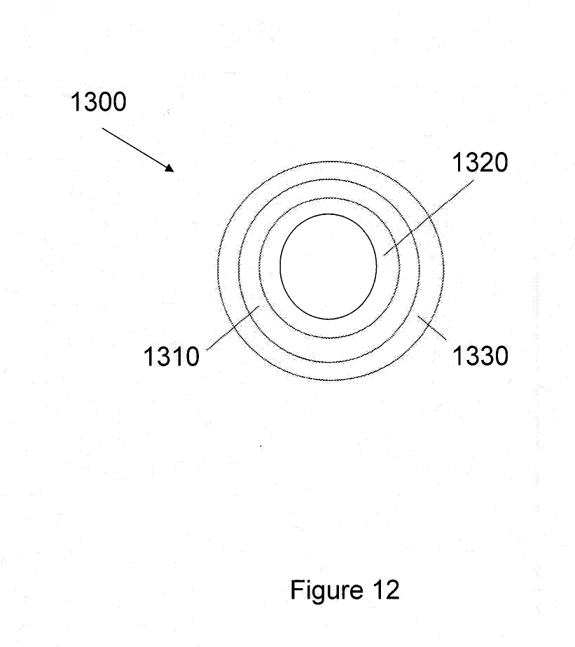

Referring to FIG. 12, in some embodiments, the present invention provides a structural support 1300 that includes a cylindrical structural core 1310, an inner layer 1320 disposed concentrically within the core, the inner layer including a first CNT-infused fiber material in a first thermoset matrix, and an outer layer 1330 that includes a second CNT-infused fiber material in a second thermoset matrix. Cylindrical core 1310 can be any structural material and can include a fiber-reinforced matrix material. The fiber reinforcement of structural core 1310 can have CNTs disposed thereon, or CNTs can be absent from the fiber reinforcement. The matrix material of the structural core can also be a thermoset material. In some such embodiments, the inner layer first thermoset matrix and the outer layer second thermoset matrix can be the same as the structural core and thus, the matrix material is a continuum of the same material through each layer, the differences only being the presence of different fiber-reinforcement types among the three layers. Although embodiments disclosed herein related to cylindrical supports, it will be recognized by one skilled in the art, that similar support elements can be manufactured in other geometrical configurations such as triangular, square, rectangular, and the like.

In some embodiments, the structural supports of the present invention can be used in applications requiring lightning strike protection. Design elements for such applications can include any combination of selection of alterations in CNT length, CNT density, CNT orientation, fiber type, and thickness of the inner and outer layers. All of these design elements are controlled by the CNT-infusion process and post-CNT growth treatments. In some embodiments, rapid production can be achieved by using the same matrix material throughout the structural support and utilizing wet winding of the various layers with a single final cure step.

Thermoset matrix materials useful in the present invention can include any of the known matrix materials (see Mel M. Schwartz, Composite Materials Handbook (2d ed. 1992)). Thermosetting resins useful as matrix materials include phthalic/maelic type polyesters, vinyl esters, epoxies, phenolics, cyanates, bismaleimides, and nadic end-capped polyimides (e.g., PMR-15). Thermoplastic resins include polysulfones, polyamides, polycarbonates, polyphenylene oxides, polysulfides, polyether ether ketones, polyether sulfones, polyamide-imides, polyetherimides, polyimides, polyacrylates, and liquid crystalline polyester.

In some embodiments, the structural core includes a third fiber material in a third thermoset matrix. In some such embodiments, the first thermoset matrix, the second thermoset matrix, and the third thermoset matrix are the same. When all three matrix of the inner layer, outer layer and structural core include the same matrix material, a single curing step can be employed, although partial or full curing can also be employed as each layer is formed. In other embodiments, the first thermoset matrix, the second thermoset matrix, and the third thermoset matrix include at least two different thermoset resins. In some such embodiments, curing can be performed sequentially as each layer is formed. The curing temperatures of differing thermoset resins can be selected to closely match to provide even curing.

In some embodiments, the first CNT-infused fiber and the second CNT-infused fiber include, independently, CNTs having a length from between about 20 to about 500 microns, including about 20, 25, 30, 40, 45, 50, 60, 70, 80, 90, 100, 110, 120, 130, 140, 150, 200, 250, 300, 350, 400, 450, and about 500 microns, including any value in between and fractions thereof. In some embodiments CNTs can also be in a range from between about 20 microns to about 50 microns, including 20, 25, 30, 35, 40, 45, and 50 microns, including any value in between and fractions thereof. Any such lengths between about 20 microns to about 500 microns can be useful, for example, to enhance electrical and/or thermal conductivity. In some embodiments, the third fiber material of the structural core can be a third CNT-infused fiber. In some such embodiments, the third CNT-infused fiber can includes CNTs having a length from between about 0.1 microns to about 20 microns, which can be useful to enhance mechanical strength. Thus, structure enhancement can be realized with CNTs have lengths such as 0.1, 0.5, 1, 2, 3, 4, 5, 6, 7, 8, 9, 10, 11, 12, 13, 14, 15, 16, 17, 18, 19, and 20 microns, including values in between and fractions thereof.

In some embodiments, CNTs of the first CNT-infused fiber material can be present in an amount ranging from between about 10 percent by weight to about 40 percent by weight of the CNT-infused fiber. Thus, CNTs can be present at about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 percent by weight of the CNT-infused fiber, including fractions thereof. In some embodiments, the first CNT-infused fiber material can be present in an amount ranging from between about 15 microns to about 20 microns, including 15, 16, 17, 18, 19, and 20 microns including fractions thereof. Likewise, supports of the present invention can include CNTs of the second CNT-infused fiber material in an amount ranging from between about 10 percent by weight to about 40 percent by weight of the CNT-infused fiber, including about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 percent by weight of the CNT-infused fiber, including fractions thereof. In some embodiments, the second CNT-infused fiber material can be present in an amount ranging from between about 15 microns to about 20 microns, including 15, 16, 17, 18, 19, and 20 microns including fractions thereof.

In some embodiments, supports of the present invention can include a first fiber volume associated with the inner layer can be in a range from between about 20 percent to about 40 percent, including about 20, 21, 22, 23, 24, 25, 26, 27, 28, 29, 30, 31, 32, 33, 34, 35, 36, 37, 38, 39, and about 40 percent, including fractions thereof. In some embodiments, a first fiber volume associated with the inner layer can be in a range from between about 30 percent to about 40 percent, including about 30, 31, 32, 33, 34, 35, 36, 37, 38, 39, and about 40 percent, including fractions thereof. Likewise, supports of the present invention can include a second fiber volume associated with the outer layer in a range from between about 20 percent to about 40 percent, including about 20, 21, 22, 23, 24, 25, 26, 27, 28, 29, 30, 31, 32, 33, 34, 35, 36, 37, 38, 39, and 40 percent, including fractions thereof. In some embodiments, a second fiber volume associated with the outer layer can be in a range from between about 30 percent to about 40 percent, including about 30, 31, 32, 33, 34, 35, 36, 37, 38, 39, and about 40 percent, including fractions thereof. Supports of the present invention can also include a third fiber volume associated with the core in a range from between about 50 percent to about 70 percent, including about 50, 51, 52, 53, 54, 55, 56, 57, 58, 59, 60, 61, 62, 63, 64, 65, 66, 67, 68, 69, and 70 percent, including fractions thereof. In some embodiments, a third fiber volume associated with the core can be in a range from between about 60 percent to about 70 percent, including about 60, 61, 62, 63, 64, 65, 66, 67, 68, 69, and 70 percent, including fractions thereof.

In some embodiments, supports of the present invention can have an inner layer having an electrical conductivity ranging from between about 1 S/m to about 300 S/m. Likewise, the outer layer can have a second electrical conductivity ranging from between about 1 S/m to about 300 S/m. Thus, the inner and outer layers can, independently have an electrical conductivity of about 1, 2, 3, 4, 5, 6, 7, 8, 9, 10, 15, 20, 30, 40, 50, 60, 70, 80, 90, 100, 150, 200, 250, and about 300 S/m, including all values in between and fractions thereof. Some embodiments the electrical conductivity of the inner and outer layer can be in a range, independently, from between about 10 S/m to about 100 S/m, including about 10, 20, 30, 40, 50, 60, 70, 80, 90, and about 100 S/m, including any values in between and fractions thereof. These values of conductivity refer to the through thickness measurement, that is, perpendicular to the axis of the fiber and perpendicular to the support cylindrical axis as well. That is the conductivity through the thickness of the outer or inner layer.

The present invention also provides a composite that includes a thermoset matrix and a carbon nanotube (CNT)-infused fiber material that includes CNTs having lengths between about 20 microns to about 500 microns including about 20, 30, 40, 50, 60, 70, 80, 90, 100, 110, 120, 130, 140, 150, 200, 250, 300, 350, 400, 450, and 500 microns, including any value in between and fractions thereof. In some embodiments CNTs can also be in a range of lengths from between about 20 microns to about 50 microns, including 20, 25, 30, 35, 40, 45, and 50 microns, including any value in between and fractions thereof. In some such embodiments, the CNT-infused fiber material includes a carbon fiber material, as described herein further below. Such composite structures can be useful in applications where electrical and/or thermal conductivity enhancements are targeted.

In some embodiments, composites of the present invention can have CNTs on the CNT-infused fiber material present in an amount ranging from between about 10 percent by weight to about 40 percent by weight, including about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 percent by weight, including fractions thereof. In some embodiments, this range can be in an amount from between about 15 to about 20 percent by weight, including about 15, 16, 17, 18, 19, and 20 percent, including fractions thereof. In some embodiments, a first fiber volume of the CNT-infused fiber material in a first portion of the composite can be in a range from between about 20 percent to about 40 percent, including about 20, 21, 22, 23, 24, 25, 26, 27, 28, 29, 30, 31, 32, 33, 34, 35, 36, 37, 38, 39, and 40 percent. A second fiber material disposed in a second portion of the same composite can have a second fiber volume of the second fiber material in a range from about 50 percent to about 70 percent, including about 50, 51, 52, 53, 54, 55, 56, 57, 58, 59, 60, 61, 62, 63, 64, 65, 66, 67, 68, 69, and 70 percent, including fractions thereof.

In some embodiments, the present invention also provides a composite that includes a CNT-infused fiber material comprising CNTs ranging in length from between about 0.1 microns to about 15 microns and a thermoset matrix, where the CNTs are present in a range from between about 0.1 percent by weight to about 5 percent by weight of the composite. Such composites can the form of a prepreg fabric, for example, and can be useful in application targeting structural enhancements. In some such embodiments, the CNT-infused fiber material comprises can be a glass fiber material, while in other embodiments, the CNT-infused fiber material can include a carbon fiber material.

The present invention also provides a method of making a structural support that includes 1) wet winding a first CNT-infused fiber about a cylindrical mandrel in a direction substantially parallel to the mandrel axis; 2) wet winding a baseline fiber layer about the wound first CNT-infused fiber at an angle substantially non-parallel to the mandrel axis; and 3) wet winding a second CNT-infused fiber about the baseline layer in a direction substantially parallel to the mandrel axis. In some embodiments, each wet winding step includes wet winding with at least one thermoset matrix. Methods of the invention further include a step of curing the thermoset matrix material. In some embodiments, the curing step is performed as a single step after all wet winding steps have been performed, while in other embodiments, the curing step can include a full or partial cure between each wet winding step. In some embodiments, the baseline fiber layer is another CNT-infused fiber layer. In such embodiments, the CNT length can be selected for mechanical strength enhancement, such as between about 0.1 to about 50 microns as described above.

The present invention also provides a method of making a structural support that includes 1) dry winding a first CNT-infused fiber about a cylindrical mandrel in a direction substantially parallel to the mandrel axis; 2) dry winding a baseline fiber layer about the wound first CNT-infused fiber at an angle substantially non-parallel to the mandrel axis; 3) dry winding a second CNT-infused fiber about the baseline layer in a direction substantially parallel to the mandrel axis; and 4) infusing the dry wound first CNT-infused fiber, dry wound baseline fiber layer, and dry wound second CNT-infused fiber with at least one thermoset matrix. In some embodiments, such infusion can be performed after each dry winding step, while in other embodiments, thermoset matrix infusion can be performed after all the dry winding steps are complete.

In some embodiments, methods of manufacture include the use of prepregs, resin film infusion, vacuum-assisted resin transfer molding (VARTM), and any other technique employed in the art in composite manufacture. Non-limiting examples include pultrusion, extrusion, resin transfer molding (RTM), hand layup open molding, compression molding, thermoforming, autoclave molding, and filament winding.

CNT-infused carbon and glass fibers have been described in co-pending applications U.S. 2010/0178825 and Ser. No. 12/611,070 both of which are incorporated herein by reference in their entirety. Such CNT-infused fiber materials are exemplary of the types that can be used as a reinforcing material in a thermoset matrix. Other CNT-infused fiber-type materials can include metal fibers (U.S. 2010/0159240), ceramic fibers, and organic fibers, such as aramid fibers, all of which have been prepared by procedures analogous to those described below. In the CNT-infusion processes disclosed in the above-referenced applications, fiber materials are modified to provide a layer (typically, no more than a monolayer) of CNT-initiating catalyst nanoparticles on the fiber. The catalyst-laden fiber is then exposed to a CVD-based process used to grow CNTs continuously, in line. The CNTs grown are infused to the fiber material. The resultant CNT-infused fiber material is itself a composite architecture.

The CNT-infused fiber can be tailored with specific types of CNTs on the surface of fiber such that various properties can be achieved. For example, the electrical properties can be modified by applying various types, diameter, length, and density CNTs on the fiber. CNTs of a length which can provide proper CNT to CNT bridging is needed for percolation pathways which improve composite conductivity. Because fiber spacing is typically equivalent to or greater than one fiber diameter, from about 5 to about 50 microns, CNTs can be at least this length to achieve effective electrical pathways. Shorter length CNTs can be used to enhance structural properties.

In some embodiments, a CNT-infused fiber material includes CNTs of varying lengths along different sections of the same fiber material. When used as a thermoset composite reinforcement, such multifunctional CNT-infused fibers enhance more than one property of the composite in which they are incorporated.

In some embodiments, a first amount of carbon nanotubes is infused to the fiber material. This amount is selected such that the value of at least one property selected from the group consisting of tensile strength, Young's Modulus, shear strength, shear modulus, toughness, compression strength, compression modulus, density, EM wave absorptivity/reflectivity, acoustic transmittance, electrical conductivity, and thermal conductivity of the carbon nanotube-infused fiber material differs from the value of the same property of the fiber material itself. Any of these properties of the resultant CNT-infused fiber material can be imparted to the final composite.

Tensile strength can include three different measurements: 1) Yield strength which evaluates the stress at which material strain changes from elastic deformation to plastic deformation, causing the material to deform permanently; 2) Ultimate strength which evaluates the maximum stress a material can withstand when subjected to tension, compression or shearing; and 3) Breaking strength which evaluates the stress coordinate on a stress-strain curve at the point of rupture. Composite shear strength evaluates the stress at which a material fails when a load is applied perpendicular to the fiber direction. Compression strength evaluates the stress at which a material fails when a compressive load is applied.

Multiwalled carbon nanotubes, in particular, have the highest tensile strength of any material yet measured, with a tensile strength of 63 GPa having been achieved. Moreover, theoretical calculations have indicated possible tensile strengths of CNTs of about GPa. Thus, CNT-infused fiber materials are expected to have substantially higher ultimate strength compared to the parent fiber material. As described above, the increase in tensile strength will depend on the exact nature of the CNTs used as well as the density and distribution on the fiber material. CNT-infused fiber materials can exhibit a 2 to 3 times increase in tensile properties, for example. Exemplary CNT-infused fiber materials can have as high as three times the shear strength as the parent unfunctionalized fiber material and as high as 2.5 times the compression strength. Such increases in the strength of the reinforcing fiber material translate to increased strength in a thermoset in which the CNT-infused fiber is incorporated.

Young's modulus is a measure of the stiffness of an isotropic elastic material. It is defined as the ratio of the uniaxial stress over the uniaxial strain in the range of stress in which Hooke's Law holds. This can be experimentally determined from the slope of a stress-strain curve created during tensile tests conducted on a sample of the material.

Electrical conductivity or specific conductance is a measure of a material's ability to conduct an electric current. CNTs with particular structural parameters such as the degree of twist, which relates to CNT chirality, can be highly conducting, thus exhibiting metallic properties. A recognized system of nomenclature (M. S. Dresselhaus, et al. Science of Fullerenes and Carbon Nanotubes, Academic Press, San Diego, Calif. pp. 756-760, (1996)) has been formalized and is recognized by those skilled in the art with respect to CNT chirality. Thus, for example, CNTs are distinguished from each other by a double index (n,m) where n and m are integers that describe the cut and wrapping of hexagonal graphite so that it makes a tube when it is wrapped onto the surface of a cylinder and the edges are sealed together. When the two indices are the same, m=n, the resultant tube is said to be of the “arm-chair” (or n,n) type, since when the tube is cut perpendicular to the CNT axis only the sides of the hexagons are exposed and their pattern around the periphery of the tube edge resembles the arm and seat of an arm chair repeated n times. Arm-chair CNTs, in particular SWNTs, are metallic, and have extremely high electrical and thermal conductivity. In addition, such SWNTs have-extremely high tensile strength.

In addition to the degree of twist CNT diameter also effects electrical conductivity. As described above, CNT diameter can be controlled by use of controlled size CNT-forming catalyst nanoparticles. CNTs can also be formed as semi-conducting materials. Conductivity in multi-walled CNTs (MWNTs) can be more complex. Interwall reactions within MWNTs can redistribute current over individual tubes non-uniformly. By contrast, there is no change in current across different parts of metallic single-walled nanotubes (SWNTs). Carbon nanotubes also have very high thermal conductivity, comparable to diamond crystal and in-plane graphite sheet.

CNTs infused on the fibers can be any of a number of cylindrically-shaped allotropes of carbon of the fullerene family including single-walled carbon nanotubes (SWNTs), double-walled carbon nanotubes (DWNTs), multi-walled carbon nanotubes (MWNTs). CNTs can be capped by a fullerene-like structure or open-ended. CNTs include those that encapsulate other materials.

The CNTs infused on portions of the fiber material are generally uniform in length. “Uniform length” means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length.

The CNTs infused on portions of the fiber material are generally uniform in distribution as well. Uniform in distribution refers to the consistency of density of CNTs on a fiber material. “Uniform distribution” means that the CNTs have a density on the fiber material with tolerances of plus or minus about 10% coverage defined as the percentage of the surface area of the fiber covered by CNTs. This is equivalent to ±1500 CNTs/μm² for an 8 nm diameter CNT with 5 walls. Such a figure assumes the space inside the CNTs as fillable.

The present disclosure is directed, in part, to carbon nanotube-infused (“CNT-infused”) carbon fiber materials. The infusion of CNTs to the fiber material can serve many functions including, for example, as a sizing agent to protect against damage from moisture, oxidation, abrasion, and compression. A CNT-based sizing can also serve as an interface between the fiber material and a matrix material in a composite. The CNTs can also serve as one of several sizing agents coating the fiber material.

Moreover, CNTs infused on a fiber material can alter various properties of the fiber material, such as thermal and/or electrical conductivity, and/or tensile strength, for example. The processes employed to make CNT-infused fiber materials provide CNTs with substantially uniform length and distribution to impart their useful properties uniformly over the fiber material that is being modified. Furthermore, the processes disclosed herein are suitable for the generation of CNT-infused fiber materials of spoolable dimensions.

The present disclosure is also directed, in part, to processes for making CNT-infused fiber materials. The processes disclosed herein can be applied to nascent fiber materials generated de novo before, or in lieu of, application of a typical sizing solution to the fiber material. Alternatively, the processes disclosed herein can utilize a commercial fiber material, for example, a tow, that already has a sizing applied to its surface. In such embodiments, the sizing can be removed to provide a direct interface between the fiber material and the synthesized CNTs, although a barrier coating and/or transition metal particle can serve as an intermediate layer providing indirect infusion, as explained further below. After CNT synthesis further sizing agents can be applied to the fiber material as desired.

The processes described herein allow for the continuous production of carbon nanotubes of uniform length and distribution along spoolable lengths of tow, tapes, fabrics and other 3D woven structures. While various mats, woven and non-woven fabrics and the like can be functionalized by processes of the invention, it is also possible to generate such higher ordered structures from the parent tow, yarn or the like after CNT functionalization of these parent materials. For example, a CNT-infused woven fabric can be generated from a CNT-infused fiber tow.

In some embodiments, the present invention provides a composition that includes a carbon nanotube (CNT)-infused fiber material. The CNT-infused fiber material includes a fiber material of spoolable dimensions, a barrier coating conformally disposed about the fiber material, and carbon nanotubes (CNTs) infused to the fiber material. The infusion of CNTs to the fiber material can include a bonding motif of direct bonding of individual CNTs to the fiber material or indirect bonding via a transition metal NP, barrier coating, or both.

Without being bound by theory, transition metal NPs, which serve as a CNT-forming catalyst, can catalyze CNT growth by forming a CNT growth seed structure. In one embodiment, the CNT-forming catalyst can remain at the base of the fiber material, locked by the barrier coating, and infused to the surface of the fiber material. In such a case, the seed structure initially formed by the transition metal nanoparticle catalyst is sufficient for continued non-catalyzed seeded CNT growth without allowing the catalyst to move along the leading edge of CNT growth, as often observed in the art. In such a case, the NP serves as a point of attachment for the CNT to the fiber material. The presence of the barrier coating can also lead to further indirect bonding motifs. For example, the CNT forming catalyst can be locked into the barrier coating, as described above, but not in surface contact with fiber material. In such a case a stacked structure with the barrier coating disposed between the CNT forming catalyst and fiber material results. In either case, the CNTs formed are infused to the fiber material. In some embodiments, some barrier coatings will still allow the CNT growth catalyst to follow the leading edge of the growing nanotube. In such cases, this can result in direct bonding of the CNTs to the fiber material or, optionally, to the barrier coating. Regardless of the nature of the actual bonding motif formed between the carbon nanotubes and the fiber material, the infused CNT is robust and allows the CNT-infused fiber material to exhibit carbon nanotube properties and/or characteristics.

Again, without being bound by theory, when growing CNTs on carbon fiber materials, the elevated temperatures and/or any residual oxygen and/or moisture that can be present in the reaction chamber can damage the carbon fiber material. Moreover, the carbon fiber material itself can be damaged by reaction with the CNT-forming catalyst itself. That is the carbon fiber material can behave as a carbon feedstock to the catalyst at the reaction temperatures employed for CNT synthesis. Such excess carbon can disturb the controlled introduction of the carbon feedstock gas and can even serve to poison the catalyst by overloading it with carbon. The barrier coating employed in the invention is designed to facilitate CNT synthesis on carbon fiber materials. Without being bound by theory, the coating can provide a thermal barrier to heat degradation and/or can be a physical barrier preventing exposure of the carbon fiber material to the environment at the elevated temperatures. Alternatively or additionally, it can minimize the surface area contact between the CNT-forming catalyst and the carbon fiber material and/or it can mitigate the exposure of the carbon fiber material to the CNT-forming catalyst at CNT growth temperatures.

Compositions having CNT-infused fiber materials are provided in which the CNTs are substantially uniform in length. In the continuous process described herein, the residence time of the fiber material in a CNT growth chamber can be modulated to control CNT growth and ultimately, CNT length. This provides a means to control specific properties of the CNTs grown. CNT length can also be controlled through modulation of the carbon feedstock and carrier gas flow rates and reaction temperature. Additional control of the CNT properties can be obtained by controlling, for example, the size of the catalyst used to prepare the CNTs. For example, 1 nm transition metal nanoparticle catalysts can be used to provide SWNTs in particular. Larger catalysts can be used to prepare predominantly MWNTs.

Additionally, the CNT growth processes employed are useful for providing a CNT-infused fiber material with uniformly distributed CNTs on carbon fiber materials while avoiding bundling and/or aggregation of the CNTs that can occur in processes in which pre-formed CNTs are suspended or dispersed in a solvent solution and applied by hand to the fiber material. Such aggregated CNTs tend to adhere weakly to a carbon fiber material and the characteristic CNT properties are weakly expressed, if at all. In some embodiments, the maximum distribution density, expressed as percent coverage, that is, the surface area of fiber covered, can be as high as about 55% assuming about 8 nm diameter CNTs with 5 walls. This coverage is calculated by considering the space inside the CNTs as being “fillable” space. Various distribution/density values can be achieved by varying catalyst dispersion on the surface as well as controlling gas composition and process speed. Typically for a given set of parameters, a percent coverage within about 10% can be achieved across a fiber surface. Higher density and shorter CNTs are useful for improving mechanical properties, while longer CNTs with lower density are useful for improving thermal and electrical properties, although increased density is still favorable. A lower density can result when longer CNTs are grown. This can be the result of the higher temperatures and more rapid growth causing lower catalyst particle yields.

The compositions of the invention having CNT-infused fiber materials can include a fiber material such as a filament, a fiber yarn, a fiber tow, a tape, a fiber-braid, a woven fabric, a non-woven fiber mat, a fiber ply, and other 3D woven structures. Filaments include high aspect ratio carbon fibers having diameters ranging in size from between about 1 micron to about 100 microns. Fiber tows are generally compactly associated bundles of filaments and are usually twisted together to give yarns.

Yarns include closely associated bundles of twisted filaments. Each filament diameter in a yarn is relatively uniform. Yarns have varying weights described by their ‘tex,’ expressed as weight in grams of 1000 linear meters, or denier, expressed as weight in pounds of 10,000 yards, with a typical tex range usually being between about 200 tex to about 2000 tex.

Tows include loosely associated bundles of untwisted filaments. As in yarns, filament diameter in a tow is generally uniform. Tows also have varying weights and the tex range is usually between 200 tex and 2000 tex. They are frequently characterized by the number of thousands of filaments in the tow, for example 12K tow, 24K tow, 48K tow, and the like.

Tapes are materials that can be assembled as weaves or can represent non-woven flattened tows. Tapes can vary in width and are generally two-sided structures similar to ribbon. Processes of the present invention are compatible with CNT infusion on one or both sides of a tape. CNT-infused tapes can resemble a “carpet” or “forest” on a flat substrate surface. Again, processes of the invention can be performed in a continuous mode to functionalize spools of tape.

Fiber-braids represent rope-like structures of densely packed fibers. Such structures can be assembled from carbon yarns, for example. Braided structures can include a hollow portion or a braided structure can be assembled about another core material.

In some embodiments a number of primary fiber material structures can be organized into fabric or sheet-like structures. These include, for example, woven fabrics, non-woven fiber mat and fiber ply, in addition to the tapes described above. Such higher ordered structures can be assembled from parent tows, yarns, filaments or the like, with CNTs already infused in the parent fiber. Alternatively such structures can serve as the substrate for the CNT infusion processes described herein.

There are three types of carbon fiber which are categorized based on the precursors used to generate the fibers, any of which can be used in the invention: Rayon, Polyacrylonitrile (PAN) and Pitch. Carbon fiber from rayon precursors, which are cellulosic materials, has relatively low carbon content at about 20% and the fibers tend to have low strength and stiffness. Polyacrylonitrile (PAN) precursors provide a carbon fiber with a carbon content of about 55%. Carbon fiber based on a PAN precursor generally has a higher tensile strength than carbon fiber based on other carbon fiber precursors due to a minimum of surface defects.

Pitch precursors based on petroleum asphalt, coal tar, and polyvinyl chloride can also be used to produce carbon fiber. Although pitches are relatively low in cost and high in carbon yield, there can be issues of non-uniformity in a given batch.

Other fiber material types include various glass materials such as S-Glass and E-glass fibers, for example. Fiber material types useful in the invention include any known synthetic or natural fibers. Other useful fiber materials include aramid fibers such as KEVLAR®, basalt fibers, metal fibers, and ceramic fibers.

CNTs useful for infusion to fiber materials include single-walled CNTs, double-walled CNTs, multi-walled CNTs, and mixtures thereof. The exact CNTs to be used depends on the application of the CNT-infused fiber. CNTs can be used for thermal and/or electrical conductivity applications, or as insulators. In some embodiments, the infused carbon nanotubes are single-wall nanotubes. In some embodiments, the infused carbon nanotubes are multi-wall nanotubes. In some embodiments, the infused carbon nanotubes are a combination of single-wall and multi-wall nanotubes. There are some differences in the characteristic properties of single-wall and multi-wall nanotubes that, for some end uses of the fiber, dictate the synthesis of one or the other type of nanotube. For example, single-walled nanotubes can be semi-conducting or metallic, while multi-walled nanotubes are metallic.

CNTs lend their characteristic properties such as mechanical strength, low to moderate electrical resistivity, high thermal conductivity, and the like to the CNT-infused fiber material. For example, in some embodiments, the electrical resistivity of a carbon nanotube-infused fiber material is lower than the electrical resistivity of a parent fiber material. More generally, the extent to which the resulting CNT-infused fiber expresses these characteristics can be a function of the extent and density of coverage of the fiber by the carbon nanotubes. Any amount of the fiber surface area, from 0-55% of the fiber can be covered assuming an 8 nm diameter, 5-walled MWNT (again this calculation counts the space inside the CNTs as fellable). This number is lower for smaller diameter CNTs and more for greater diameter CNTs. 55% surface area coverage is equivalent to about 15,000 CNTs/micron². Further CNT properties can be imparted to the fiber material in a manner dependent on CNT length, as described above. Infused CNTs can vary in length ranging from between about 1 micron to about 500 microns, including 1 micron, 2 microns, 3 microns, 4 micron, 5, microns, 6, microns, 7 microns, 8 microns, 9 microns, 10 microns, 15 microns, 20 microns, 25 microns, 30 microns, 35 microns, 40 microns, 45 microns, 50 microns, 60 microns, 70 microns, 80 microns, 90 microns, 100 microns, 150 microns, 200 microns, 250 microns, 300 microns, 350 microns, 400 microns, 450 microns, 500 microns, and all values in between. CNTs can also be less than about 1 micron in length, including about 0.5 microns, for example. CNTs can also be greater than 500 microns, including for example, 510 microns, 520 microns, 550 microns, 600 microns, 700 microns and all values in between.

Compositions of the invention can incorporate CNTs have a length from about 1 micron to about 10 microns. Such CNT lengths can be useful in application to increase shear strength. With respect to increases in mechanical strength, in general, CNTs can be shorter than 1 micron while providing enhanced mechanical strength. In some such embodiments, CNTs can range in length from between about 0.1 to about 1 micron. CNTs can also have a length from about 5 to about 70 microns. Such CNT lengths can be useful in applications for increased tensile strength if the CNTs are aligned in the fiber direction. CNTs can also have a length from about 10 microns to about 100 microns. Such CNT lengths can be useful to increase electrical/thermal properties as well as mechanical properties. The process used in the invention can also provide CNTs having a length from about 100 microns to about 500 microns, which can also be beneficial to increase electrical and thermal properties. Such control of CNT length is readily achieved through modulation of carbon feedstock and inert gas flow rates coupled with varying linespeeds and growth temperature.

In some embodiments, compositions that include spoolable lengths of CNT-infused fiber materials can have various uniform regions with different lengths of CNTs. For example, it can be desirable to have a first portion of CNT-infused fiber material with uniformly shorter CNT lengths to enhance shear strength properties, and a second portion of the same spoolable material with a uniform longer CNT length to enhance electrical or thermal properties.

Processes of the invention for CNT infusion to fiber materials allow control of the CNT lengths with uniformity and in a continuous process allowing spoolable fiber materials to be functionalized with CNTs at high rates. With material residence times between 5 to 300 seconds, linespeeds in a continuous process for a system that is 3 feet long can be in a range anywhere from about 0.5 ft/min to about 36 ft/min and greater. The speed selected depends on various parameters as explained further below.

In some embodiments, a material residence time of about 5 to about 30 seconds can produce CNTs having a length between about 1 micron to about 10 microns. In some embodiments, a material residence time of about 30 to about 180 seconds can produce CNTs having a length between about 10 microns to about 100 microns. In still further embodiments, a material residence time of about 180 to about 300 seconds can produce CNTs having a length between about 100 microns to about 500 microns. One skilled in the art will recognize that these ranges are approximate and that CNT length can also be modulated by reaction temperatures, and carrier and carbon feedstock concentrations and flow rates.

CNT-infused fiber materials of the invention include a barrier coating. Barrier coatings can include for example an alkoxysilane, methylsiloxane, an alumoxane, alumina nanoparticles, spin on glass and glass nanoparticles. As described below, the CNT-forming catalyst can be added to the uncured barrier coating material and then applied to the fiber material together. In other embodiments the barrier coating material can be added to the carbon fiber material prior to deposition of the CNT-forming catalyst. The barrier coating material can be of a thickness sufficiently thin to allow exposure of the CNT-forming catalyst to the carbon feedstock for subsequent CVD growth. In some embodiments, the thickness is less than or about equal to the effective diameter of the CNT-forming catalyst. In some embodiments, the thickness of the barrier coating is in a range from between about 10 nm to about 100 nm. The barrier coating can also be less than 10 nm, including 1 nm, 2 nm, 3 nm, 4 nm, 5 nm, 6 nm, 7 nm, 8 nm, 9 nm, 10 nm, and any value in between.

Without being bound by theory, the barrier coating can serve as an intermediate layer between the fiber material and the CNTs and serves to mechanically infuse the CNTs to the fiber material. Such mechanical infusion still provides a robust system in which the fiber material serves as a platform for organizing the CNTs while still imparting properties of the CNTs to the fiber material. Moreover, the benefit of including a barrier coating is the immediate protection it provides the fiber material from chemical damage due to exposure to moisture and/or any thermal damage due to heating of the fiber material at the temperatures used to promote CNT growth.

The infused CNTs disclosed herein can effectively function as a replacement for conventional fiber “sizing.” The infused CNTs are more robust than conventional sizing materials and can improve the fiber-to-matrix interface in composite materials and, more generally, improve fiber-to-fiber interfaces. Indeed, the CNT-infused fiber materials disclosed herein are themselves composite materials in the sense the CNT-infused fiber material properties will be a combination of those of the fiber material as well as those of the infused CNTs. Consequently, embodiments of the present invention provide a means to impart desired properties to a fiber material that otherwise lack such properties or possesses them in insufficient measure. Fiber materials can be tailored or engineered to meet the requirements of specific applications. The CNTs acting as sizing can protect carbon fiber materials from absorbing moisture due to the hydrophobic CNT structure. Moreover, hydrophobic matrix materials, as further exemplified below, interact well with hydrophobic CNTs to provide improved fiber to matrix interactions.

Despite the beneficial properties imparted to a fiber material having infused CNTs described above, the compositions of the present invention can include further “conventional” sizing agents. Such sizing agents vary widely in type and function and include, for example, surfactants, anti-static agents, lubricants, siloxanes, alkoxysilanes, aminosilanes, silanes, silanols, polyvinyl alcohol, starch, and mixtures thereof. Such secondary sizing agents can be used to protect the CNTs themselves or provide further properties to the fiber not imparted by the presence of the infused CNTs.

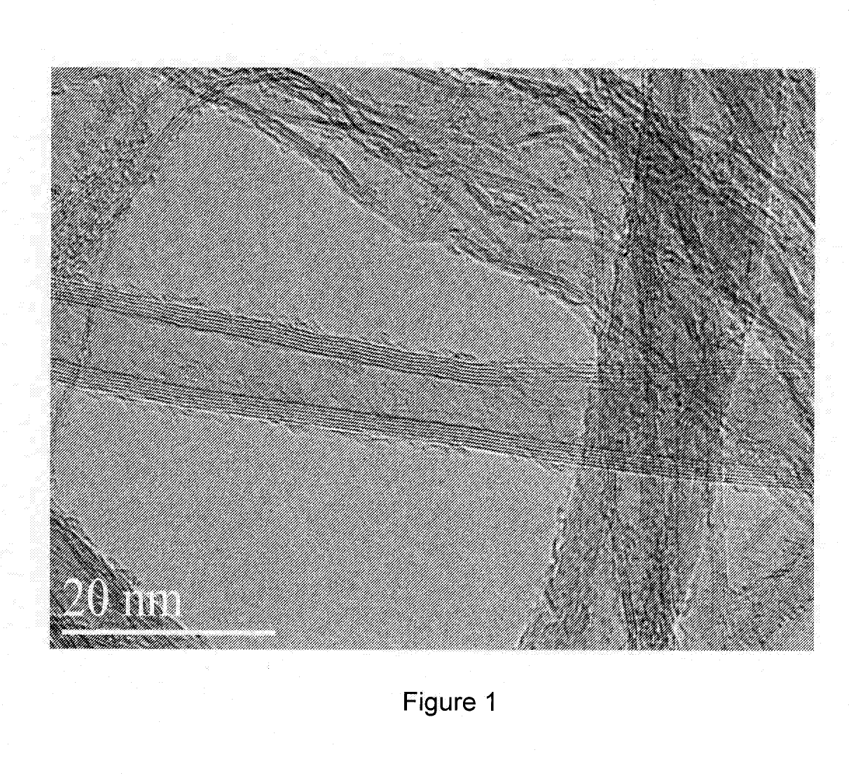

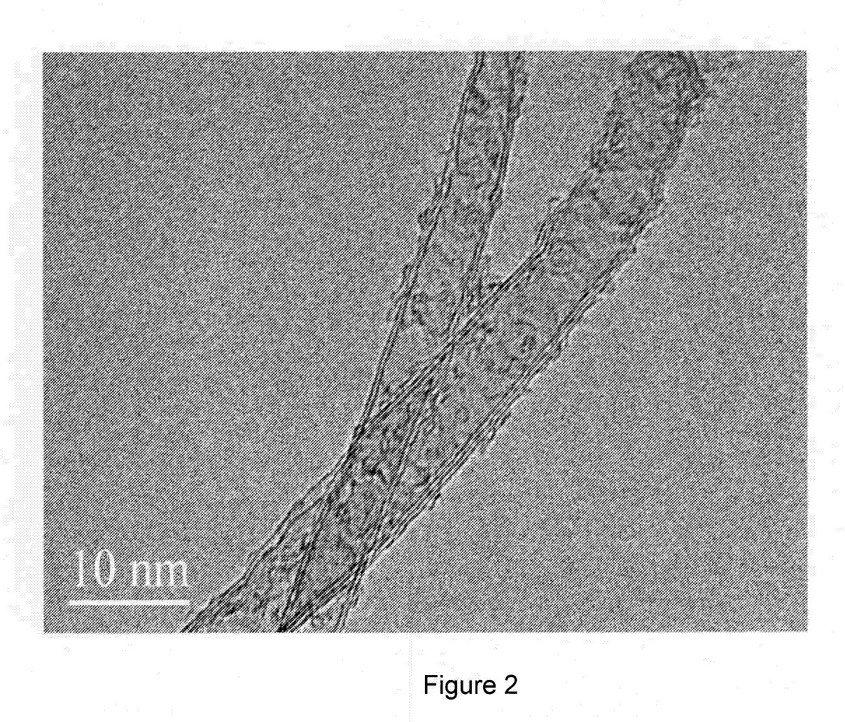

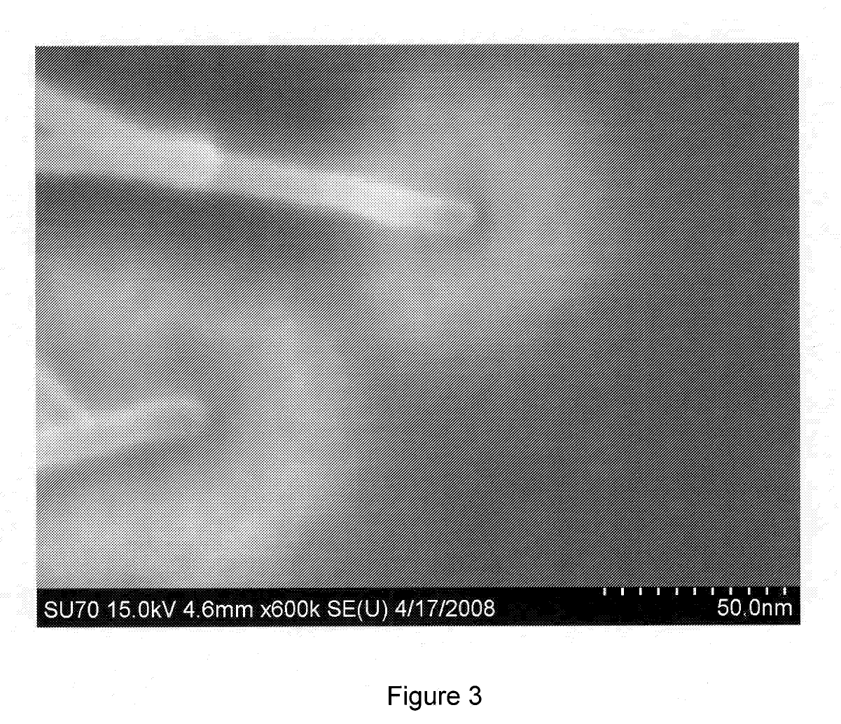

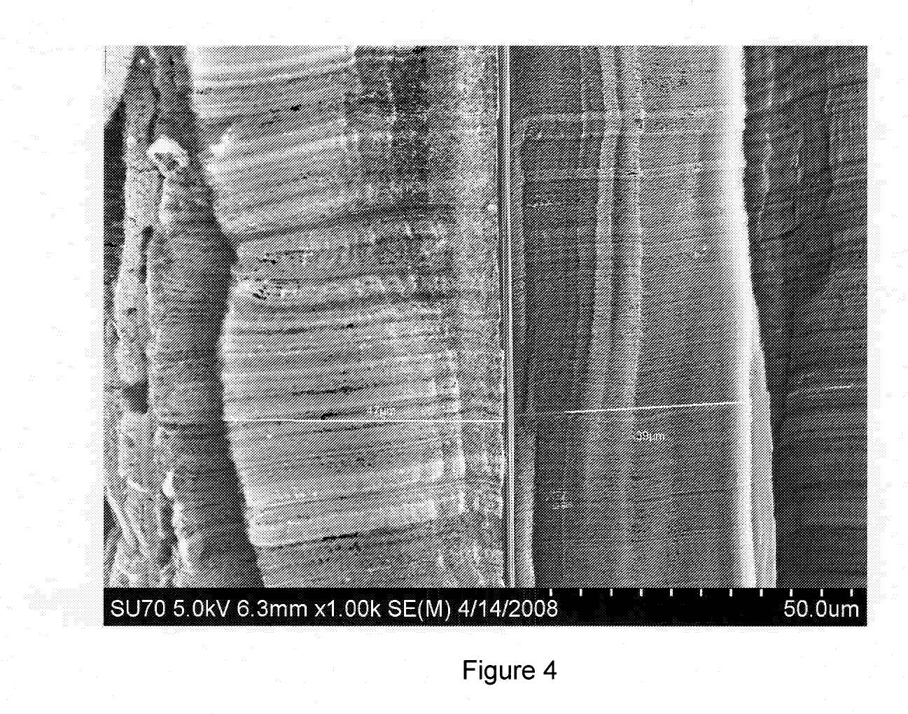

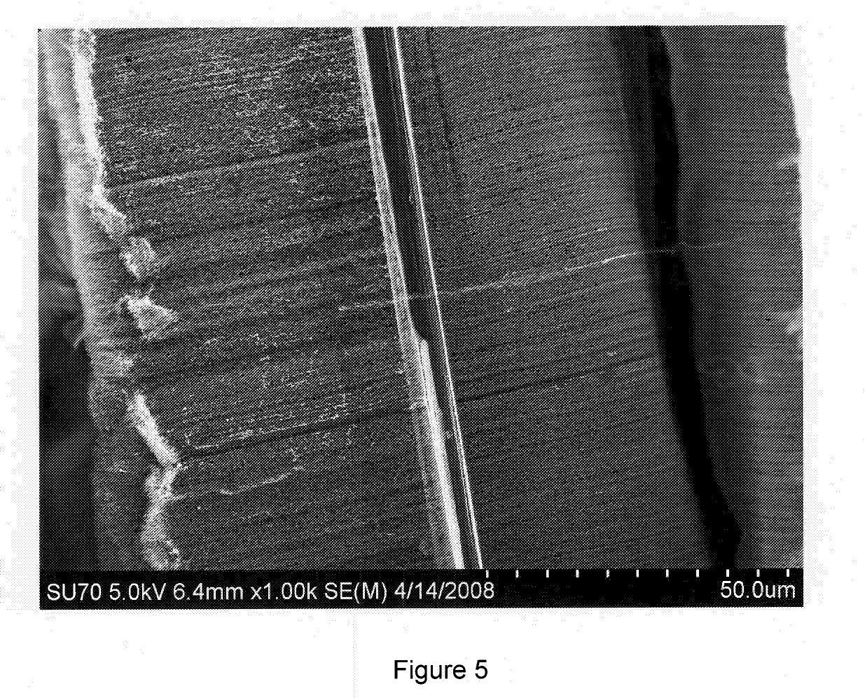

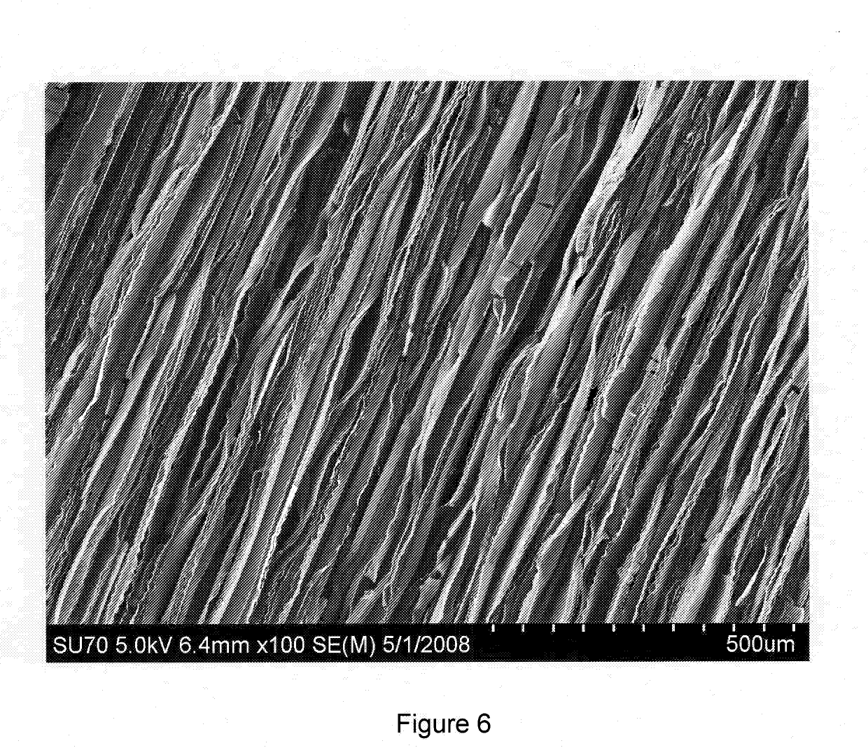

FIG. 1-6 shows TEM and SEM images of fiber materials prepared by the processes described herein. The procedures for preparing these materials are further detailed below and in Examples I-III. FIGS. 1 and 2 show TEM images of multi-walled and double-walled carbon nanotubes, respectively, that were prepared on an AS4 carbon fiber in a continuous process. FIG. 3 shows a scanning electron microscope (SEM) image of CNTs growing from within the barrier coating after the CNT-forming nanoparticle catalyst was mechanically infused to a carbon fiber material surface. FIG. 4 shows a SEM image demonstrating the consistency in length distribution of CNTs grown on a fiber material to within 20% of a targeted length of about 40 microns. FIG. 5 shows an SEM image demonstrating the effect of a barrier coating on CNT growth. Dense, well aligned CNTs grew where barrier coating was applied and no CNTs grew where barrier coating was absent. FIG. 6 shows a low magnification SEM of CNTs on fiber demonstrating the uniformity of CNT density across the fibers within about 10%.

In some embodiments the present invention provides a continuous process for CNT infusion that includes (a) disposing a carbon nanotube-forming catalyst on a surface of a carbon fiber material of spoolable dimensions; and (b) synthesizing carbon nanotubes directly on the fiber material, thereby forming a carbon nanotube-infused fiber material. For a 9 foot long system, the linespeed of the process can range from between about 1.5 ft/min to about 108 ft/min. The linespeeds achieved by the process described herein allow the formation of commercially relevant quantities of CNT-infused fiber materials with short production times. For example, at 36 ft/min linespeed, the quantities of CNT-infused fibers (over 5% infused CNTs on fiber by weight) can exceed over 100 pound or more of material produced per day in a system that is designed to simultaneously process 5 separate tows (20 lb/tow). Systems can be made to produce more tows at once or at faster speeds by repeating growth zones. Moreover, some steps in the fabrication of CNTs, as known in the art, have prohibitively slow rates preventing a continuous mode of operation. For example, in a typical process known in the art, a CNT-forming catalyst reduction step can take 1-12 hours to perform. CNT growth itself can also be time consuming, for example requiring tens of minutes for CNT growth, precluding the rapid linespeeds realized in the present invention. The process described herein overcomes such rate limiting steps.

The CNT-infused fiber material-forming processes of the invention can avoid CNT entanglement that occurs when trying to apply suspensions of pre-formed carbon nanotubes to fiber materials. That is, because pre-formed CNTs are not fused to the fiber material, the CNTs tend to bundle and entangle. The result is a poorly uniform distribution of CNTs that weakly adhere to the fiber material. However, processes of the present invention can provide, if desired, a highly uniform entangled CNT mat on the surface of the fiber material by reducing the growth density. The CNTs grown at low density are infused in the fiber material first. In such embodiments, the fibers do not grow dense enough to induce vertical alignment, the result is entangled mats on the fiber material surfaces. By contrast, manual application of pre-formed CNTs does not insure uniform distribution and density of a CNT mat on the fiber material.

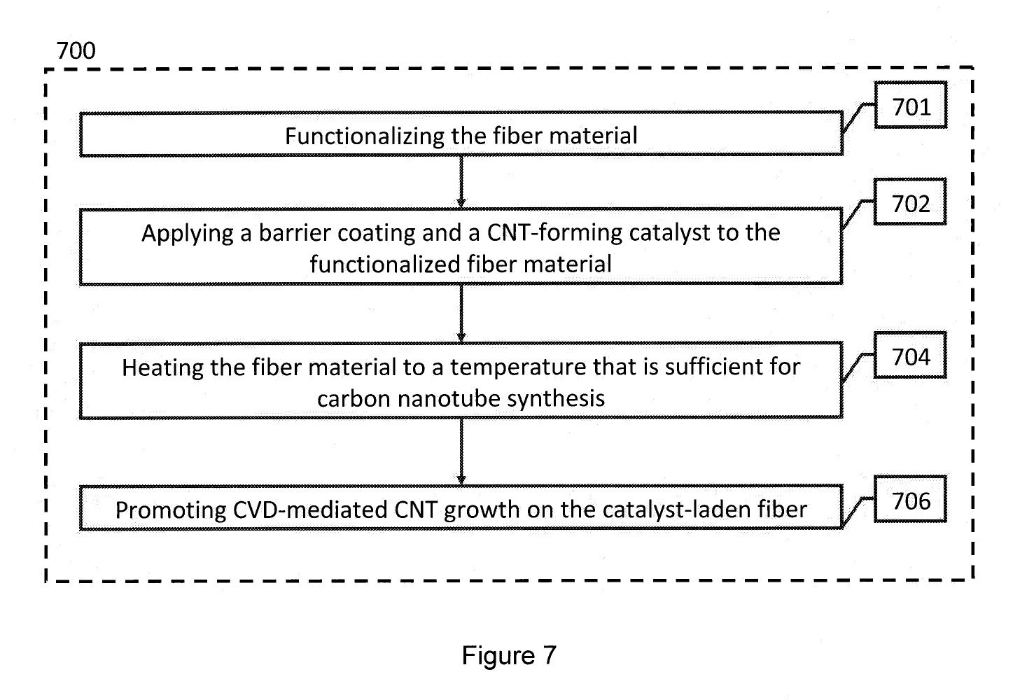

FIG. 7 depicts a flow diagram of process 700 for producing CNT-infused fiber material in accordance with an illustrative embodiment of the present invention.

Process 700 includes at least the operations of:

701: Functionalizing the fiber material.

702: Applying a barrier coating and a CNT-forming catalyst to the functionalized fiber material.

704: Heating the fiber material to a temperature that is sufficient for carbon nanotube synthesis.

706: Promoting CVD-mediated CNT growth on the catalyst-laden fiber.

In step 701, the fiber material is functionalized to promote surface wetting of the fibers and to improve adhesion of the barrier coating.

To infuse carbon nanotubes into a fiber material, the carbon nanotubes are synthesized on the fiber material which is conformally coated with a barrier coating. In one embodiment, this is accomplished by first conformally coating the fiber material with a barrier coating and then disposing nanotube-forming catalyst on the barrier coating, as per operation 702. In some embodiments, the barrier coating can be partially cured prior to catalyst deposition. This can provide a surface that is receptive to receiving the catalyst and allowing it to embed in the barrier coating, including allowing surface contact between the CNT forming catalyst and the fiber material. In such embodiments, the barrier coating can be fully cured after embedding the catalyst. In some embodiments, the barrier coating is conformally coated over the fiber material simultaneously with deposition of the CNT-form catalyst. Once the CNT-forming catalyst and barrier coating are in place, the barrier coating can be fully cured.

In some embodiments, the barrier coating can be fully cured prior to catalyst deposition. In such embodiments, a fully cured barrier-coated fiber material can be treated with a plasma to prepare the surface to accept the catalyst. For example, a plasma treated fiber material having a cured barrier coating can provide a roughened surface in which the CNT-forming catalyst can be deposited. The plasma process for “roughing” the surface of the barrier thus facilitates catalyst deposition. The roughness is typically on the scale of nanometers. In the plasma treatment process craters or depressions are formed that are nanometers deep and nanometers in diameter. Such surface modification can be achieved using a plasma of any one or more of a variety of different gases, including, without limitation, argon, helium, oxygen, nitrogen, and hydrogen. In some embodiments, plasma roughing can also be performed directly in the fiber material itself. This can facilitate adhesion of the barrier coating to the fiber material.

As described further below and in conjunction with FIG. 7, the catalyst is prepared as a liquid solution that contains CNT-forming catalyst that comprise transition metal nanoparticles. The diameters of the synthesized nanotubes are related to the size of the metal particles as described above. In some embodiments, commercial dispersions of CNT-forming transition metal nanoparticle catalyst are available and are used without dilution, in other embodiments commercial dispersions of catalyst can be diluted. Whether to dilute such solutions can depend on the desired density and length of CNT to be grown as described above.

With reference to the illustrative embodiment of FIG. 7, carbon nanotube synthesis is shown based on a chemical vapor deposition (CVD) process and occurs at elevated temperatures. The specific temperature is a function of catalyst choice, but will typically be in a range of about 500 to 1000° C. Accordingly, operation 704 involves heating the barrier-coated fiber material to a temperature in the aforementioned range to support carbon nanotube synthesis.

In operation 706, CVD-promoted nanotube growth on the catalyst-laden carbon fiber material is then performed. The CVD process can be promoted by, for example, a carbon-containing feedstock gas such as acetylene, ethylene, and/or ethanol. The CNT synthesis processes generally use an inert gas (nitrogen, argon, helium) as a primary carrier gas. The carbon feedstock is provided in a range from between about 0% to about 15% of the total mixture. A substantially inert environment for CVD growth is prepared by removal of moisture and oxygen from the growth chamber.

In the CNT synthesis process, CNTs grow at the sites of a CNT-forming transition metal nanoparticle catalyst. The presence of the strong plasma-creating electric field can be optionally employed to affect nanotube growth. That is, the growth tends to follow the direction of the electric field. By properly adjusting the geometry of the plasma spray and electric field, vertically-aligned CNTs (i.e., perpendicular to the fiber material) can be synthesized. Under certain conditions, even in the absence of a plasma, closely-spaced nanotubes will maintain a vertical growth direction resulting in a dense array of CNTs resembling a carpet or forest. The presence of the barrier coating can also influence the directionality of CNT growth.

The operation of disposing a catalyst on the fiber material can be accomplished by spraying or dip coating a solution or by gas phase deposition via, for example, a plasma process. The choice of techniques can be coordinated with the mode with which the barrier coating is applied. Thus, in some embodiments, after forming a solution of a catalyst in a solvent, catalyst can be applied by spraying or dip coating the barrier coated fiber material with the solution, or combinations of spraying and dip coating. Either technique, used alone or in combination, can be employed once, twice, thrice, four times, up to any number of times to provide a fiber material that is sufficiently uniformly coated with CNT-forming catalyst. When dip coating is employed, for example, a fiber material can be placed in a first dip bath for a first residence time in the first dip bath. When employing a second dip bath, the fiber material can be placed in the second dip bath for a second residence time. For example, fiber materials can be subjected to a solution of CNT-forming catalyst for between about 3 seconds to about 90 seconds depending on the dip configuration and linespeed. Employing spraying or dip coating processes, a fiber material with a surface density of catalyst of less than about 5% surface coverage to as high as about 80% coverage, in which the CNT-forming catalyst nanoparticles are nearly monolayer. In some embodiments, the process of coating the CNT-forming catalyst on the fiber material should produce no more than a monolayer. For example, CNT growth on a stack of CNT-forming catalyst can erode the degree of infusion of the CNT to the fiber material. In other embodiments, the transition metal catalyst can be deposited on the fiber material using evaporation techniques, electrolytic deposition techniques, and other processes known to those skilled in the art, such as addition of the transition metal catalyst to a plasma feedstock gas as a metal organic, metal salt or other composition promoting gas phase transport.

Because processes of the invention are designed to be continuous, a spoolable fiber material can be dip-coated in a series of baths where dip coating baths are spatially separated. In a continuous process in which nascent fibers are being generated de novo, dip bath or spraying of CNT-forming catalyst can be the first step after applying and curing or partially curing a barrier coating to the fiber material. Application of the barrier coating and a CNT-forming catalyst can be performed in lieu of application of a sizing, for newly formed fiber materials. In other embodiments, the CNT-forming catalyst can be applied to newly formed fibers in the presence of other sizing agents after barrier coating. Such simultaneous application of CNT-forming catalyst and other sizing agents can still provide the CNT-forming catalyst in surface contact with the barrier coating of the fiber material to insure CNT infusion.

The catalyst solution employed can be a transition metal nanoparticle which can be any d-block transition metal as described above. In addition, the nanoparticles can include alloys and non-alloy mixtures of d-block metals in elemental form or in salt form, and mixtures thereof. Such salt forms include, without limitation, oxides, carbides, and nitrides. Non-limiting exemplary transition metal NPs include Ni, Fe, Co, Mo, Cu, Pt, Au, and Ag and salts thereof and mixtures thereof. In some embodiments, such CNT-forming catalysts are disposed on the fiber by applying or infusing a CNT-forming catalyst directly to the fiber material simultaneously with barrier coating deposition. Many of these transition metal catalysts are readily commercially available from a variety of suppliers, including, for example, Ferrotec Corporation (Bedford, N.H.).

Catalyst solutions used for applying the CNT-forming catalyst to the fiber material can be in any common solvent that allows the CNT-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the CNT-forming catalyst nanoparticles. Concentrations of CNT-forming catalyst can be in a range from about 1:1 to 1:10000 catalyst to solvent. Such concentrations can be used when the barrier coating and CNT-forming catalyst is applied simultaneously as well.

In some embodiments heating of the carbon fiber material can be at a temperature that is between about 500° C. and 1000° C. to synthesize carbon nanotubes after deposition of the CNT-forming catalyst. Heating at these temperatures can be performed prior to or substantially simultaneously with introduction of a carbon feedstock for CNT growth.

In some embodiments, the present invention provides a process that includes removing sizing agents from a fiber material, applying a barrier coating conformally over the fiber material, applying a CNT-forming catalyst to the fiber material, heating the fiber material to at least 500° C., and synthesizing carbon nanotubes on the fiber material. In some embodiments, operations of the CNT-infusion process include removing sizing from a fiber material, applying a barrier coating to the fiber material, applying a CNT-forming catalyst to the fiber, heating the fiber to CNT-synthesis temperature and CVD-promoted CNT growth the catalyst-laden fiber material. Thus, where commercial fiber materials are employed, processes for constructing CNT-infused fibers can include a discrete step of removing sizing from the fiber material before disposing barrier coating and the catalyst on the fiber material.

The step of synthesizing carbon nanotubes can include numerous techniques for forming carbon nanotubes, including those disclosed in co-pending U.S. Patent Application No. US 2004/0245088 which is incorporated herein by reference. The CNTs grown on fibers of the present invention can be accomplished by techniques known in the art including, without limitation, micro-cavity, thermal or plasma-enhanced CVD techniques, laser ablation, arc discharge, and high pressure carbon monoxide (HiPCO). During CVD, in particular, a barrier coated fiber material with CNT-forming catalyst disposed thereon, can be used directly. In some embodiments, any conventional sizing agents can be removed prior CNT synthesis. In some embodiments, acetylene gas is ionized to create a jet of cold carbon plasma for CNT synthesis. The plasma is directed toward the catalyst-bearing fiber material. Thus, in some embodiments synthesizing CNTs on a fiber material includes (a) forming a carbon plasma; and (b) directing the carbon plasma onto the catalyst disposed on the fiber material. The diameters of the CNTs that are grown are dictated by the size of the CNT-forming catalyst as described above. In some embodiments, the sized fiber substrate is heated to between about 550 to about 800° C. to facilitate CNT synthesis. To initiate the growth of CNTs, two gases are bled into the reactor: a process gas such as argon, helium, or nitrogen, and a carbon-containing gas, such as acetylene, ethylene, ethanol or methane. CNTs grow at the sites of the CNT-forming catalyst.

In some embodiments, the CVD growth is plasma-enhanced. A plasma can be generated by providing an electric field during the growth process. CNTs grown under these conditions can follow the direction of the electric field. Thus, by adjusting the geometry of the reactor vertically aligned carbon nanotubes can be grown radially about a cylindrical fiber. In some embodiments, a plasma is not required for radial growth about the fiber. For carbon fiber materials that have distinct sides such as tapes, mats, fabrics, plies, and the like, catalyst can be disposed on one or both sides and correspondingly, CNTs can be grown on one or both sides as well.

As described above, CNT-synthesis is performed at a rate sufficient to provide a continuous process for functionalizing spoolable carbon fiber materials. Numerous apparatus configurations faciliate such continuous synthesis as exemplified below.

In some embodiments, CNT-infused fiber materials can be constructed in an “all plasma” process. An all plasma process can begin with roughing the fiber material with a plasma as described above to improve fiber surface wetting characteristics and provide a more conformal barrier coating, as well as improve coating adhesion via mechanical interlocking and chemical adhesion through the use of functionalization of the fiber material by using specific reactive gas species, such as oxygen, nitrogen, hydrogen in argon or helium based plasmas.

Barrier coated fiber materials pass through numerous further plasma-mediated steps to form the final CNT-infused product. In some embodiments, the all plasma process can include a second surface modification after the barrier coating is cured. This is a plasma process for “roughing” the surface of the barrier coating on the fiber material to facilitate catalyst deposition. As described above, surface modification can be achieved using a plasma of any one or more of a variety of different gases, including, without limitation, argon, helium, oxygen, ammonia, hydrogen, and nitrogen.

After surface modification, the barrier coated fiber material proceeds to catalyst application. This is a plasma process for depositing the CNT-forming catalyst on the fibers. The CNT-forming catalyst is typically a transition metal as described above. The transition metal catalyst can be added to a plasma feedstock gas as a precursor in the form of a ferrofluid, a metal organic, metal salt or other composition for promoting gas phase transport. The catalyst can be applied at room temperature in the ambient environment with neither vacuum nor an inert atmosphere being required. In some embodiments, the fiber material is cooled prior to catalyst application.

Continuing the all-plasma process, carbon nanotube synthesis occurs in a CNT-growth reactor. This can be achieved through the use of plasma-enhanced chemical vapor deposition, wherein carbon plasma is sprayed onto the catalyst-laden fibers. Since carbon nanotube growth occurs at elevated temperatures (typically in a range of about 500 to 1000° C. depending on the catalyst), the catalyst-laden fibers can be heated prior to exposing to the carbon plasma. For the infusion process, the fiber material can be optionally heated until it softens. After heating, the fiber material is ready to receive the carbon plasma. The carbon plasma is generated, for example, by passing a carbon containing gas such as acetylene, ethylene, ethanol, and the like, through an electric field that is capable of ionizing the gas. This cold carbon plasma is directed, via spray nozzles, to the carbon fiber material. The fiber material can be in close proximity to the spray nozzles, such as within about 1 centimeter of the spray nozzles, to receive the plasma. In some embodiments, heaters are disposed above the fiber material at the plasma sprayers to maintain the elevated temperature of the fiber material.

Another configuration for continuous carbon nanotube synthesis involves a special rectangular reactor for the synthesis and growth of carbon nanotubes directly on fiber materials. The reactor can be designed for use in a continuous in-line process for producing carbon-nanotube bearing fibers. In some embodiments, CNTs are grown via a chemical vapor deposition (“CVD”) process at atmospheric pressure and at elevated temperature in the range of about 550° C. to about 800° C. in a multi-zone reactor. The fact that the synthesis occurs at atmospheric pressure is one factor that facilitates the incorporation of the reactor into a continuous processing line for CNT-on-fiber synthesis. Another advantage consistent with in-line continuous processing using such a zone reactor is that CNT growth occurs in a seconds, as opposed to minutes (or longer) as in other procedures and apparatus configurations typical in the art.

CNT synthesis reactors in accordance with the various embodiments include the following features:

Rectangular Configured Synthesis Reactors: The cross section of a typical CNT synthesis reactor known in the art is circular. There are a number of reasons for this including, for example, historical reasons (cylindrical reactors are often used in laboratories) and convenience (flow dynamics are easy to model in cylindrical reactors, heater systems readily accept circular tubes (quartz, etc.), and ease of manufacturing. Departing from the cylindrical convention, the present invention provides a CNT synthesis reactor having a rectangular cross section. The reasons for the departure are as follows: 1. Since many fiber materials that can be processed by the reactor are relatively planar such as flat tape or sheet-like in form, a circular cross section is an inefficient use of the reactor volume. This inefficiency results in several drawbacks for cylindrical CNT synthesis reactors including, for example, a) maintaining a sufficient system purge; increased reactor volume requires increased gas flow rates to maintain the same level of gas purge. This results in a system that is inefficient for high volume production of CNTs in an open environment; b) increased carbon feedstock gas flow; the relative increase in inert gas flow, as per a) above, requires increased carbon feedstock gas flows. Consider that the volume of a 12K fiber tow is 2000 times less than the total volume of a synthesis reactor having a rectangular cross section. In an equivalent growth cylindrical reactor (i.e., a cylindrical reactor that has a width that accommodates the same planarized carbon fiber material as the rectangular cross-section reactor), the volume of the fiber material is 17,500 times less than the volume of the chamber. Although gas deposition processes, such as CVD, are typically governed by pressure and temperature alone, volume has a significant impact on the efficiency of deposition. With a rectangular reactor there is a still excess volume. This excess volume facilitates unwanted reactions; yet a cylindrical reactor has about eight times that volume. Due to this greater opportunity for competing reactions to occur, the desired reactions effectively occur more slowly in a cylindrical reactor chamber. Such a slow down in CNT growth, is problematic for the development of a continuous process. One benefit of a rectangular reactor configuration is that the reactor volume can be decreased by using a small height for the rectangular chamber to make this volume ratio better and reactions more efficient. In some embodiments of the present invention, the total volume of a rectangular synthesis reactor is no more than about 3000 times greater than the total volume of a fiber material being passed through the synthesis reactor. In some further embodiments, the total volume of the rectangular synthesis reactor is no more than about 4000 times greater than the total volume of the fiber material being passed through the synthesis reactor. In some still further embodiments, the total volume of the rectangular synthesis reactor is less than about 10,000 times greater than the total volume of the fiber material being passed through the synthesis reactor. Additionally, it is notable that when using a cylindrical reactor, more carbon feedstock gas is required to provide the same flow percent as compared to reactors having a rectangular cross section. It should be appreciated that in some other embodiments, the synthesis reactor has a cross section that is described by polygonal forms that are not rectangular, but are relatively similar thereto and provide a similar reduction in reactor volume relative to a reactor having a circular cross section; c) problematic temperature distribution; when a relatively small-diameter reactor is used, the temperature gradient from the center of the chamber to the walls thereof is minimal. But with increased size, such as would be used for commercial-scale production, the temperature gradient increases. Such temperature gradients result in product quality variations across a fiber material substrate (i.e., product quality varies as a function of radial position). This problem is substantially avoided when using a reactor having a rectangular cross section. In particular, when a planar substrate is used, reactor height can be maintained constant as the size of the substrate scales upward. Temperature gradients between the top and bottom of the reactor are essentially negligible and, as a consequence, thermal issues and the product-quality variations that result are avoided. 2. Gas introduction: Because tubular furnaces are normally employed in the art, typical CNT synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall CNT growth rate because the incoming feedstock gas is continuously replenishing at the hottest portion of the system, which is where CNT growth is most active. This constant gas replenishment is an important aspect to the increased growth rate exhibited by the rectangular CNT reactors.

Zoning. Chambers that provide a relatively cool purge zone depend from both ends of the rectangular synthesis reactor. Applicants have determined that if hot gas were to mix with the external environment (i.e., outside of the reactor), there would be an increase in degradation of the carbon fiber material. The cool purge zones provide a buffer between the internal system and external environments. Typical CNT synthesis reactor configurations known in the art typically require that the substrate is carefully (and slowly) cooled. The cool purge zone at the exit of the present rectangular CNT growth reactor achieves the cooling in a short period of time, as required for the continuous in-line processing.

Non-contact, hot-walled, metallic reactor. In some embodiments, a hot-walled reactor is made of metal is employed, in particular stainless steel. This may appear counterintuitive because metal, and stainless steel in particular, is more susceptible to carbon deposition (i.e., soot and by-product formation). Thus, most CNT reactor configurations use quartz reactors because there is less carbon deposited, quartz is easier to clean, and quartz facilitates sample observation. However, Applicants have observed that the increased soot and carbon deposition on stainless steel results in more consistent, faster, more efficient, and more stable CNT growth. Without being bound by theory it has been indicated that, in conjunction with atmospheric operation, the CVD process occurring in the reactor is diffusion limited. That is, the catalyst is “overfed;” too much carbon is available in the reactor system due to its relatively higher partial pressure (than if the reactor was operating under partial vacuum). As a consequence, in an open system—especially a clean one—too much carbon can adhere to catalyst particles, compromising their ability to synthesize CNTs. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, react with the catalyst at a rate that does not poison the catalyst. Existing systems run “cleanly” which, if they were open for continuous processing, would produced a much lower yield of CNTs at reduced growth rates.

Although it is generally beneficial to perform CNT synthesis “dirty” as described above, certain portions of the apparatus, such as gas manifolds and inlets, can nonetheless negatively impact the CNT growth process when soot created blockages. In order to combat this problem, such areas of the CNT growth reaction chamber can be protected with soot inhibiting coatings such as silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

Combined Catalyst Reduction and CNT Synthesis. In the CNT synthesis reactor disclosed herein, both catalyst reduction and CNT growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present invention due, at least in part, to the fact that carbon feedstock gas is introduced at the center of the reactor, not the end as would be typical in the art using cylindrical reactors. The reduction process occurs as the fibers enter the heated zone; by this point, the gas has had time to react with the walls and cool off prior to reacting with the catalyst and causing the oxidation reduction (via hydrogen radical interactions). It is this transition region where the reduction occurs. At the hottest isothermal zone in the system, the CNT growth occurs, with the greatest growth rate occurring proximal to the gas inlets near the center of the reactor.

In some embodiments, when loosely affiliated fiber materials, such as tow are employed, the continuous process can include steps that spreads out the strands and/or filaments of the tow. Thus, as a tow is unspooled it can be spread using a vacuum-based fiber spreading system, for example. When employing sized fibers, which can be relatively stiff, additional heating can be employed in order to “soften” the tow to facilitate fiber spreading. The spread fibers which comprise individual filaments can be spread apart sufficiently to expose an entire surface area of the filaments, thus allowing the tow to more efficiently react in subsequent process steps. Such spreading can approach between about 4 inches to about 6 inches across for a 3 k tow. The spread tow can pass through a surface treatment step that is composed of a plasma system as described above. After a barrier coating is applied and roughened, spread fibers then can pass through a CNT-forming catalyst dip bath. The result is fibers of the tow that have catalyst particles distributed radially on their surface. The catalyzed-laden fibers of the tow then enter an appropriate CNT growth chamber, such as the rectangular chamber described above, where a flow through atmospheric pressure CVD or PE-CVD process is used to synthesize the CNTs at rates as high as several microns per second. The fibers of the tow, now with radially aligned CNTs, exit the CNT growth reactor.

In some embodiments, CNT-infused fiber materials can pass through yet another treatment process that, in some embodiments is a plasma process used to functionalize the CNTs. Additional functionalization of CNTs can be used to promote their adhesion to particular resins. Thus, in some embodiments, the present invention provides CNT-infused fiber materials having functionalized CNTs.

As part of the continuous processing of spoolable carbon fiber materials, the a CNT-infused fiber material can further pass through a sizing dip bath to apply any additional sizing agents which can be beneficial in a final product. Finally if wet winding is desired, the CNT-infused fiber materials can be passed through a resin bath and wound on a mandrel or spool. The resulting fiber material/resin combination locks the CNTs on the fiber material allowing for easier handling and composite fabrication. In some embodiments, CNT infusion is used to provide improved filament winding. Thus, CNTs formed on fibers such as carbon tow, are passed through a resin bath to produce resin-impregnated, CNT-infused tow. After resin impregnation, the carbon tow can be positioned on the surface of a rotating mandrel by a delivery head. The tow can then be wound onto the mandrel in a precise geometric pattern in known fashion.

The winding process described above provides pipes, tubes, or other forms as are characteristically produced via a male mold. But the forms made from the winding process disclosed herein differ from those produced via conventional filament winding processes. Specifically, in the process disclosed herein, the forms are made from composite materials that include CNT-infused tow. Such forms will therefore benefit from enhanced strength and the like, as provided by the CNT-infused tow.

In some embodiments, a continuous process for infusion of CNTs on spoolable fiber materials can achieve a linespeed between about 0.5 ft/min to about 36 ft/min. In this embodiment where the CNT growth chamber is 3 feet long and operating at a 750° C. growth temperature, the process can be run with a linespeed of about 6 ft/min to about 36 ft/min to produce, for example, CNTs having a length between about 1 micron to about 10 microns. The process can also be run with a linespeed of about 1 ft/min to about 6 ft/min to produce, for example, CNTs having a length between about 10 microns to about 100 microns. The process can be run with a linespeed of about 0.5 ft/min to about 1 ft/min to produce, for example, CNTs having a length between about 100 microns to about 200 microns. The CNT length is not tied only to linespeed and growth temperature, however, the flow rate of both the carbon feedstock and the inert carrier gases can also influence CNT length. For example, a flow rate consisting of less than 1% carbon feedstock in inert gas at high linespeeds (6 ft/min to 36 ft/min) will result in CNTs having a length between 1 micron to about 5 microns. A flow rate consisting of more than 1% carbon feedstock in inert gas at high linespeeds (6 ft/min to 36 ft/min) will result in CNTs having length between 5 microns to about 10 microns.

In some embodiments, more than one material can be run simultaneously through the process. For example, multiple tapes tows, filaments, strand and the like can be run through the process in parallel. Thus, any number of pre-fabricated spools of fiber material can be run in parallel through the process and re-spooled at the end of the process. The number of spooled fiber materials that can be run in parallel can include one, two, three, four, five, six, up to any number that can be accommodated by the width of the CNT-growth reaction chamber. Moreover, when multiple fiber materials are run through the process, the number of collection spools can be less than the number of spools at the start of the process. In such embodiments, strands, tows, or the like can be sent through a further process of combining such fiber materials into higher ordered carbon fiber materials such as woven fabrics or the like. The continuous process can also incorporate a post processing chopper that facilitates the formation CNT-infused chopped fiber mats, for example.

In some embodiments, processes of the invention allow for synthesizing a first amount of a first type of carbon nanotube on the fiber material, in which the first type of carbon nanotube is selected to alter at least one first property of the fiber material. Subsequently, process of the invention allow for synthesizing a second amount of a second type of carbon nanotube on the fiber material, in which the second type of carbon nanotube is selected to alter at least one second property of the fiber material.

In some embodiments, the first amount and second amount of CNTs are different. This can be accompanied by a change in the CNT type or not. Thus, varying the density of CNTs can be used to alter the properties of the original fiber material, even if the CNT type remains unchanged. CNT type can include CNT length and the number of walls, for example. In some embodiments the first amount and the second amount are the same. If different properties are desirable in this case along the two different stretches of the spoolable material, then the CNT type can be changed, such as the CNT length. For example, longer CNTs can be useful in electrical/thermal applications, while shorter CNTs can be useful in mechanical strengthening applications.

In light of the aforementioned discussion regarding altering the properties of the fiber materials, the first type of carbon nanotube and the second type of carbon nanotube can be the same, in some embodiments, while the first type of carbon nanotube and the second type of carbon nanotube can be different, in other embodiments. Likewise, the first property and the second property can be the same, in some embodiments. For example, the EMI shielding property can be the property of interest addressed by the first amount and type of CNTs and the 2nd amount and type of CNTs, but the degree of change in this property can be different, as reflected by differing amounts, and/or types of CNTs employed. Finally, in some embodiments, the first property and the second property can be different. Again this may reflect a change in CNT type. For example the first property can be mechanical strength with shorter CNTs, while the second property can be electrical/thermal properties with longer CNTs. One skilled in the art will recognize the ability to tailor the properties of the carbon fiber material through the use of different CNT densities, CNT lengths, and the number of walls in the CNTs, such as single-walled, double-walled, and multi-walled, for example.

In some embodiments, processes of the present invention provides synthesizing a first amount of carbon nanotubes on a fiber material, such that this first amount allows the carbon nanotube-infused fiber material to exhibit a second group of properties that differ from a first group of properties exhibited by the fiber material itself. That is, selecting an amount that can alter one or more properties of the fiber material, such as tensile strength. The first group of properties and second group of properties can include at least one of the same properties, thus representing enhancing an already existing property of the fiber material. In some embodiments, CNT infusion can impart a second group of properties to the carbon nanotube-infused fiber material that is not included among the first group of properties exhibited by the fiber material itself.

In some embodiments, a first amount of carbon nanotubes is selected such that the value of at least one property selected from the group consisting of tensile strength, Young's Modulus, shear strength, shear modulus, toughness, compression strength, compression modulus, density, EM wave absorptivity/reflectivity, acoustic transmittance, electrical conductivity, and thermal conductivity of the carbon nanotube-infused fiber material differs from the value of the same property of the fiber material itself.

Tensile strength can include three different measurements: 1) Yield strength which evaluates the stress at which material strain changes from elastic deformation to plastic deformation, causing the material to deform permanently; 2) Ultimate strength which evaluates the maximum stress a material can withstand when subjected to tension, compression or shearing; and 3) Breaking strength which evaluates the stress coordinate on a stress-strain curve at the point of rupture. Composite shear strength evaluates the stress at which a material fails when a load is applied perpendicular to the fiber direction. Compression strength evaluates the stress at which a material fails when a compressive load is applied.

Multiwalled carbon nanotubes, in particular, have the highest tensile strength of any material yet measured, with a tensile strength of 63 GPa having been achieved. Moreover, theoretical calculations have indicated possible tensile strengths of CNTs of about 300 GPa. Thus, CNT-infused fiber materials are expected to have substantially higher ultimate strength compared to the parent fiber material. As described above, the increase in tensile strength will depend on the exact nature of the CNTs used as well as the density and distribution on the fiber material. CNT-infused fiber materials can exhibit a tow to three times increase in tensile properties, for example. Exemplary CNT-infused fiber materials can have as high as three times the shear strength as the parent unfunctionalized fiber material and as high as 2.5 times the compression strength.

Young's modulus is a measure of the stiffness of an isotropic elastic material. It is defined as the ratio of the uniaxial stress over the uniaxial strain in the range of stress in which Hooke's Law holds. This can be experimentally determined from the slope of a stress-strain curve created during tensile tests conducted on a sample of the material.

Electrical conductivity or specific conductance is a measure of a material's ability to conduct an electric current. CNTs with particular structural parameters such as the degree of twist, which relates to CNT chirality, can be highly conducting, thus exhibiting metallic properties. A recognized system of nomenclature (M. S. Dresselhaus, et al. Science of Fullerenes and Carbon Nanotubes, Academic Press, San Diego, Calif. pp. 756-760, (1996)) has been formalized and is recognized by those skilled in the art with respect to CNT chirality. Thus, for example, CNTs are distinguished from each other by a double index (n,m) where n and m are integers that describe the cut and wrapping of hexagonal graphite so that it makes a tube when it is wrapped onto the surface of a cylinder and the edges are sealed together. When the two indices are the same, m=n, the resultant tube is said to be of the “arm-chair” (or n,n) type, since when the tube is cut perpendicular to the CNT axis only the sides of the hexagons are exposed and their pattern around the periphery of the tube edge resembles the arm and seat of an arm chair repeated n times. Arm-chair CNTs, in particular SWNTs, are metallic, and have extremely high electrical and thermal conductivity. In addition, such SWNTs have-extremely high tensile strength.

In addition to the degree of twist CNT diameter also effects electrical conductivity. As described above, CNT diameter can be controlled by use of controlled size CNT-forming catalyst nanoparticles. CNTs can also be formed as semi-conducting materials. Conductivity in multi-walled CNTs (MWNTs) can be more complex. Interwall reactions within MWNTs can redistribute current over individual tubes non-uniformly. By contrast, there is no change in current across different parts of metallic single-walled nanotubes (SWNTs). Carbon nanotubes also have very high thermal conductivity, comparable to diamond crystal and in-plane graphite sheet. The CNT-infused fiber materials can benefit from the presence of CNTs not only in the properties described above, but can also provide lighter materials in the process. Thus, such lower density and higher strength materials translates to greater strength to weight ratio.

It is understood that modifications which do not substantially affect the activity of the various embodiments of this invention are also included within the definition of the invention provided herein. Accordingly, the following examples are intended to illustrate but not limit the present invention.

### EXAMPLE I

This example shows how a carbon fiber material can be infused with CNTs in a continuous process to target electrical conductivity improvements in thermoset matrix composites.

In this example, the maximum loading of CNTs on fibers is targeted. 34-700 12 k carbon fiber tow with a tex value of 800 (Grafil Inc., Sacramento, Calif.) is implemented as the carbon fiber substrate. The individual filaments in this carbon fiber tow have a diameter of approximately 7 μm.

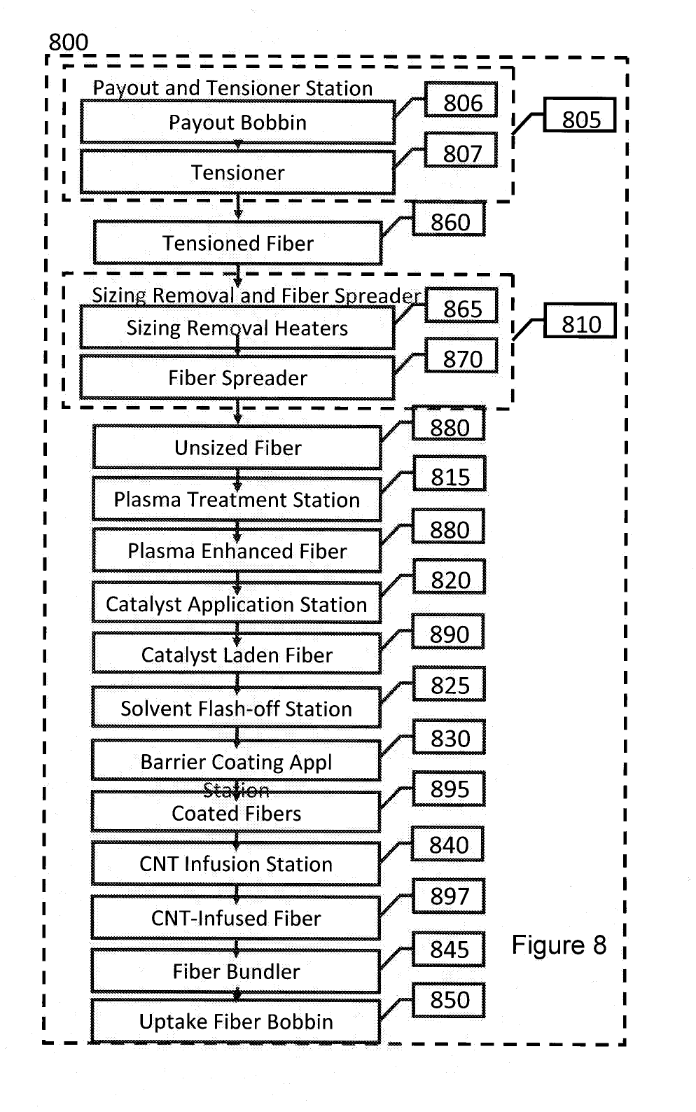

FIG. 8 depicts system 800 for producing CNT-infused fiber in accordance with the illustrative embodiment of the present invention. System 800 includes a carbon fiber material payout and tensioner station 805, sizing removal and fiber spreader station 810, plasma treatment station 815, catalyst application station 820, solvent flash-off station 825, barrier coating application station 830, CNT-infusion station 840, fiber bundler station 845, and carbon fiber material uptake bobbin 850, interrelated as shown.

Payout and tension station 805 includes payout bobbin 806 and tensioner 807. The payout bobbin delivers carbon fiber material 860 to the process; the fiber is tensioned via tensioner 807. For this example, the carbon fiber is processed at a linespeed of 2 ft/min.

Fiber material 860 is delivered to sizing removal and fiber spreader station 810 which includes sizing removal heaters 865 and fiber spreader 870. At this station, any “sizing” that is on fiber 860 is removed. Typically, removal is accomplished by burning the sizing off of the fiber. Any of a variety of heating means can be used for this purpose, including, for example, an infrared heater, a muffle furnace, and other non-contact heating processes. Sizing removal can also be accomplished chemically. The fiber spreader separates the individual elements of the fiber. Various techniques and apparatuses can be used to spread fiber, such as pulling the fiber over and under flat, uniform-diameter bars, or over and under variable-diameter bars, or over bars with radially-expanding grooves and a kneading roller, over a vibratory bar, etc. Spreading the fiber enhances the effectiveness of downstream operations, such as plasma application, barrier coating application, and catalyst application, by exposing more fiber surface area.

Multiple sizing removal heaters 865 can be placed throughout the fiber spreader 870 which allows for gradual, simultaneous desizing and spreading of the fibers. Payout and tension station 805 and sizing removal and fiber spreader station 810 are routinely used in the fiber industry; those skilled in the art will be familiar with their design and use.

The temperature and time required for burning off the sizing vary as a function of (1) the sizing material and (2) the commercial source/identity of carbon fiber material 860. A conventional sizing on a carbon fiber material can be removed at about 650° C. At this temperature, it can take as long as 15 minutes to ensure a complete burn off of the sizing. Increasing the temperature above this burn temperature can reduce burn-off time. Thermogravimetric analysis is used to determine minimum burn-off temperature for sizing for a particular commercial product.

Depending on the timing required for sizing removal, sizing removal heaters may not necessarily be included in the CNT-infusion process proper; rather, removal can be performed separately (e.g., in parallel, etc.). In this way, an inventory of sizing-free carbon fiber material can be accumulated and spooled for use in a CNT-infused fiber production line that does not include fiber removal heaters. The sizing-free fiber is then spooled in payout and tension station 805. This production line can be operated at higher speed than one that includes sizing removal.

Unsized fiber 880 is delivered to plasma treatment station 815. For this example, atmospheric plasma treatment is utilized in a ‘downstream’ manner from a distance of 1 mm from the spread carbon fiber material. The gaseous feedstock is comprised of 100% helium.

Plasma enhanced fiber 885 is delivered to catalyst application station 820. In this example, an iron oxide-based CNT forming catalyst solution is employed in a dip coating configuration. The solution is ‘EFH-1’ (Ferrotec Corporation, Bedford, N.H.) diluted in hexane by a dilution rate of 2000 to 1 by volume. Less than a monolayer of catalyst coating is achieved on the carbon fiber material. ‘EFH-1’ prior to dilution has a nanoparticle concentration ranging from 3-15% by volume. The iron oxide nanoparticles are of composition Fe2O3 and Fe3O4 and are approximately 8 nm in diameter.

Catalyst-laden carbon fiber material 890 is delivered to solvent flash-off station 825. The solvent flash-off station sends a stream of air across the entire carbon fiber spread. In this example, room temperature air can be employed in order to flash-off all hexane left on the catalyst-laden carbon fiber material.

After solvent flash-off, catalyst laden carbon fiber 890 is delivered to barrier coating station 830. In this illustrative example, a siloxane-based barrier coating solution is employed in a dip coating configuration. The solution is ‘Accuglass T-11 Spin-On Glass’ (Honeywell International Inc., Morristown, N.J.) diluted in isopropyl alcohol by a dilution rate of 40 to 1 by volume. The resulting barrier coating thickness on the carbon fiber material is approximately 40 nm. The barrier coating can be applied at room temperature in the ambient environment.

After solvent flash-off, catalyst-laden fiber 895 is finally advanced to CNT-infusion station 840. In this example, a rectangular reactor with a 18 inch growth zone is used to employ CVD growth at atmospheric pressure. 92.0% of the total gas flow is inert gas (Nitrogen), 2.0% is the carbon feedstock (acetylene), and the other 4.0% is hydrogen gas. The growth zone is held at 750° C. For the rectangular reactor mentioned above, 750° C. is a relatively high growth temperature, which allows for the highest growth rates possible.

After CNT-infusion, CNT-infused fiber 897 is re-bundled at fiber bundler station 845. This operation recombines the individual strands of the fiber, effectively reversing the spreading operation that was conducted at station 810.

The bundled, CNT-infused fiber 897 is wound about uptake fiber bobbin 850 for storage. CNT-infused fiber 897 is loaded with CNTs approximately 60 μm in length or about 15% CNTs by weight and is then ready for use in composite materials with enhanced electrical conductivity.

Using CNT-infused fiber 897, a composite panel is made by filament winding the fibers onto a plate mandrel. In order to make a structural panel, the fibers are wound in both the 0° and 90° directions relative to a common axis. The resulting dry wound fiber structure is removed from the winder for thermoset matrix infusion.

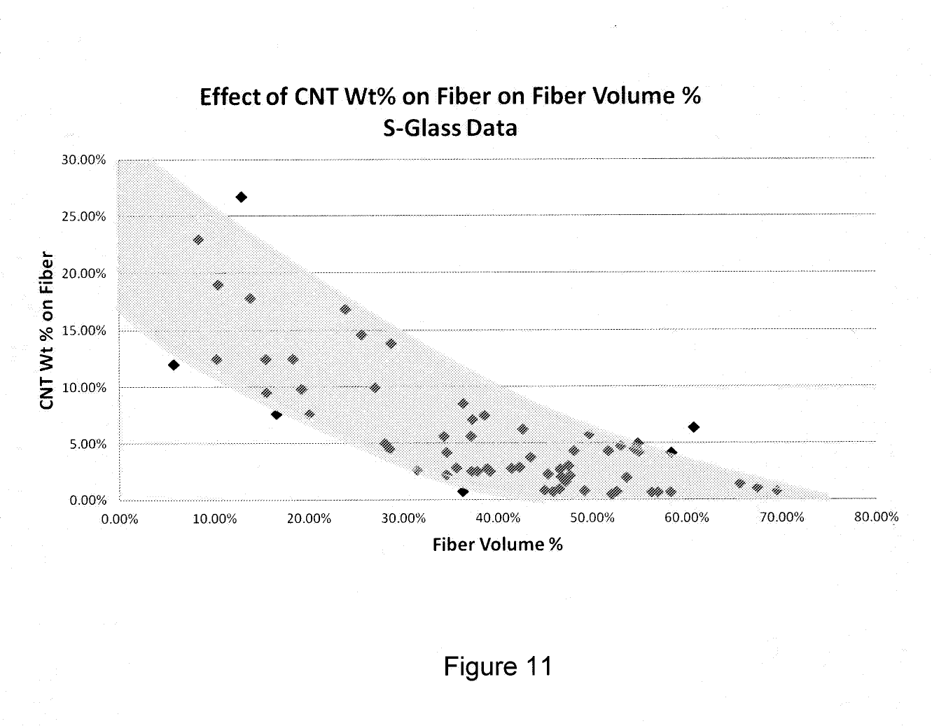

The dry wound fiber structure is infused with a thermoset resin, EPON 828, using a vacuum assisted resin transfer method (VARTM). This method is used to aid in full impregnation of the fibers with the thermoset matrix as well as to reduce the number of voids in the final composite structure. Since CNTs a higher percent of CNTs can result in a lower fiber volume percent as shown in FIG. 11, the VARTM process is used to promote increasing the overall fiber volume as well.

The resin infused structure is then cured in an oven in accordance with the resin manufacturers specifications. The resulting composite panel is trimmed and prepared for testing and evaluation. Such a panel results in an electrical conductivity of greater than 100 S/m and can be used in applications ranging from EMI shielding to lightning strike protection.

It is noteworthy that some of the operations described above can be conducted under inert atmosphere or vacuum for environmental isolation. For example, if sizing is being burned off of a carbon fiber material, the fiber can be environmentally isolated to contain off-gassing and prevent damage from moisture. For convenience, in system 800, environmental isolation is provided for all operations, with the exception of carbon fiber material payout and tensioning, at the beginning of the production line, and fiber uptake, at the end of the production line.

### EXAMPLE II

This example shows how carbon fiber material was infused with CNTs in a continuous process to target improvements in mechanical properties, specifically fracture toughness. In this case, loading of shorter CNTs on fibers was targeted. In this example, IM712 k unsized carbon fiber tow with a tex value of 442 (Hexcel Corporation, Stamford, Conn.) was implemented as the carbon fiber substrate. The individual filaments in this carbon fiber tow have a diameter of approximately 5 μm.

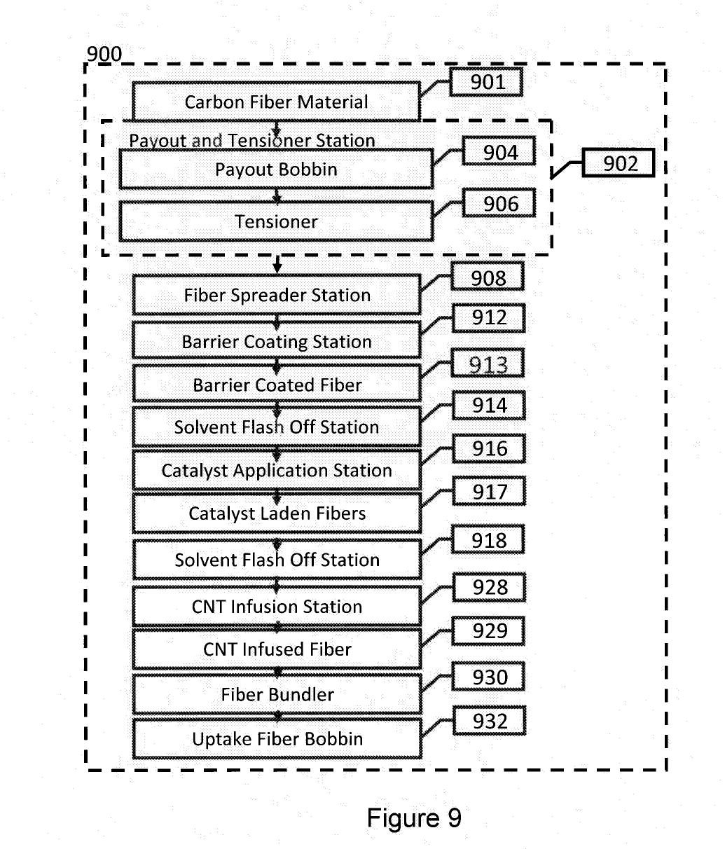

FIG. 9 depicts system 900 for producing CNT-infused fiber in accordance with the illustrative embodiment of the present invention. System 900 includes a carbon fiber material payout and tensioner station 902, fiber spreader station 908, barrier coating station 912, solvent flash-off station 914, a catalyst application station 916, a second solvent flash-off station 918, CNT-infusion station 928, fiber bundler station 930, and carbon fiber material uptake bobbin 932, interrelated as shown.

Payout and tension station 902 included payout bobbin 904 and tensioner 906. The payout bobbin delivered carbon fiber material 901 to the process; the fiber was tensioned via tensioner 906. For this example, the carbon fiber was processed at a linespeed of 2 ft/min.

Fiber material 901 was delivered to fiber spreader station 908. As this fiber was manufactured without sizing, a sizing removal process was not incorporated as part of fiber spreader station 908. The fiber spreader separated the individual elements of the fiber in a similar manner as described in fiber spreader 870.

After fiber spreading, carbon fiber material 901 was delivered to barrier coating station 912. In this example, a siloxane-based barrier coating solution was employed in a dip coating configuration. The solution was ‘Accuglass T-11 Spin-On Glass’ (Honeywell International Inc., Morristown, N.J.) diluted in isopropyl alcohol by a dilution rate of 40 to 1 by volume. The resulting barrier coating thickness on the carbon fiber material was approximately 40 nm. The barrier coating was applied at room temperature in the ambient environment.

Barrier coated carbon fiber 913 was then delivered to solvent flash-off station 914 for partial curing of the barrier coating. The solvent flash-off station sent a stream of heated air across the entire carbon fiber spread. Temperatures employed were in the range of 300° C.

Barrier coated fiber 913 was delivered to catalyst application station 916. In this example, an iron oxide based CNT forming catalyst solution was employed in a dip coating configuration. The solution was ‘EFH-1’ (Ferrotec Corporation, Bedford, N.H.) diluted in hexane by a dilution rate of 60 to 1 by volume. More than a monolayer of catalyst coating was achieved on the carbon fiber material. ‘EFH-1’ prior to dilution has a nanoparticle concentration ranging from 3-15% by volume. The iron oxide nanoparticles are of composition Fe2O3 and Fe3O4 and are approximately 8 nm in diameter.

Catalyst-laden carbon fiber material 917 was delivered to solvent flash-off station 918. The solvent flash-off station sent a stream of air across the entire carbon fiber spread. In this example, room temperature air was employed in order to flash-off all hexane left on the catalyst-laden carbon fiber material.

After solvent flash-off, catalyst laden carbon fiber 917 was finally advanced to CNT-infusion station 928. In this example, a rectangular reactor with a 18 inch growth zone was used to employ CVD growth at atmospheric pressure. 97.53% of the total gas flow was inert gas (Nitrogen) and the other 2.47% was the carbon feedstock (acetylene). The growth zone was held at 650° C. For the rectangular reactor mentioned above, 650° C. is a relatively low growth temperature, which allowed for the control of shorter CNT growth.

After CNT-infusion, CNT-infused fiber 929 as re-bundled at fiber bundler 930. This operation recombined the individual strands of the fiber, effectively reversing the spreading operation that was conducted at station 908.

The bundled, CNT-infused fiber 931 was wound about uptake fiber bobbin 932 for storage. CNT-infused fiber 929 was loaded with CNTs approximately 5 μm in length or about 2% weight CNT and was then ready for use in composite materials with enhanced mechanical properties.

CNT-infused fiber 931 was wet wound on a plate mandrel in order to demonstrate the fracture toughness improvements of a resulting composite panel. In the wet winding process, CNT-infused fiber 931 was drawn over a roller assembly and through a resin bath containing thermoset resin, EPON 828. Because a wet winding process was used, a relatively low fiber volume (38%) was observed in the resulting composite panel which corresponds to the result in FIG. 11. The wet wound composite panel was cured under pressure in accordance with the thermoset resin manufacturer specifications.

The resulting composite panel was trimmed and tested in accordance with ISO 15024—Fibre-reinforced plastic composites—Determination of mode I interlaminar fracture toughness, GIC, for unidirectionally reinforced materials. The results shown in FIG. 12 demonstrated a 45% improvement of fracture toughness compared to a similarly fabricated baseline unsized IM7 panel.

It is noteworthy that some of the operations described above can be conducted under inert atmosphere or vacuum for environmental isolation. For convenience, in system 900, environmental isolation was provided for all operations, with the exception of carbon fiber material payout and tensioning, at the beginning of the production line, and fiber uptake, at the end of the production line.

In the spirit of embodiments discussed in the description, it is also understood that the resulting CNT infused fibers from Examples I and II can be utilized together in a single structure that can provide both the electrical conductivity improvements of the longer CNTs and the fracture toughness enhancements of the shorter CNTs.

Although the invention has been described with reference to the disclosed embodiments, those skilled in the art will readily appreciate that these only illustrative of the invention. It should be understood that various modifications can be made without departing from the spirit of the invention.

What is claimed is:

1. A structural support comprising:
a cylindrical structural core;
an inner layer disposed concentrically within said core; said inner layer comprising a first CNT-infused fiber material in a first thermoset matrix; and
an outer layer comprising a second CNT-infused fiber material in a second thermoset matrix.

2. The support of claim 1, wherein the core comprises a third fiber material in a third thermoset matrix.

3. The support of claim 2, wherein said first thermoset matrix, said second thermoset matrix, and said third thermoset matrix are the same.

4. The support of claim 2, wherein said first thermoset matrix, said second thermoset matrix, and said third thermoset matrix comprise at least two different thermoset resins.

5. The support claim 1, wherein said first CNT-infused fiber and said second CNT-infused fiber comprise independently CNTs having a length from between about 20 to about 500 microns.

6. The support of claim 2, wherein the third fiber material is a third CNT-infused fiber.

7. The support of claim 6, wherein the third CNT-infused fiber comprises CNTs having a length from between about 0.1 microns to about 20 microns.

8. The support of claim 1, wherein CNTs of said first CNT-infused fiber material are present in an amount ranging from between about 10 percent by weight to about 40 percent by weight of the CNT-infused fiber.

9. The support of claim 1, wherein CNTs of said second CNT-infused fiber material are present in an amount ranging from between about 10 percent by weight to about 40 percent by weight of the CNT-infused fiber.

10. The support of claim 1, wherein a first fiber volume associated with said inner layer is in a range from between about 20 percent to about 40 percent.

11. The support of claim 1, wherein a second fiber volume associated with said outer layer is in a range from between about 20 percent to about 40 percent.

12. The support of claim 2, where a third fiber volume associated with said core is in a range from between about 50 percent to about 70 percent.

13. The support of claim 1, wherein said inner layer has an electrical conductivity ranging from between about 1 S/m to about 300 S/m.

14. The support of claim 1, wherein said outer layer has a second electrical conductivity ranging from between about 1 S/m to about 300 S/m.

15. A composite comprising:
a thermoset matrix; and
a carbon nanotube (CNT)-infused fiber material comprising CNTs having lengths between about 20 microns to about 500 microns.

16. The composite of claim 15, wherein said CNT-infused fiber material comprises a carbon fiber material.

17. The composite of claim 15, wherein CNTs of said CNT-infused fiber material are present in an amount ranging from between about 10 percent by weight to about 40 percent by weight. 15-20 preferred

18. The composite of claim 15, wherein a first fiber volume of said CNT-infused fiber material in a first portion of said composite is in a range from between about 20 percent to about 40 percent. 30-40 preferred

19. The composite of claim 15, further comprising a second fiber material disposed in a second portion of said composite; wherein a second fiber volume of said second fiber material is about 50 percent to about 70 percent. 60-70 preferred

20. A composite comprising:
a CNT-infused fiber material comprising CNTs ranging in length from between about 0.1 microns to about 20 microns; and preferred 5-15
a thermoset matrix;
wherein said CNTs are present in a range from between about 0.1 percent by weight to about 5 percent by weight of the composite.

21. The composite of claim 20, wherein said composite is a prepreg fabric.

22. The composite of claim 20, wherein said CNT-infused fiber material comprises a glass fiber material.

23. The composite of claim 20, wherein said CNT-infused fiber material comprises a carbon fiber material.

24. A method of making a structural support comprising:
wet winding a first CNT-infused fiber about a cylindrical mandrel in a direction substantially parallel to the mandrel axis;
wet winding a baseline layer about said wound first CNT-infused fiber at an angle substantially non-parallel to the mandrel axis; and
wet winding a second CNT-infused fiber about the baseline layer in a direction substantially parallel to the mandrel axis;
wherein each wet winding step comprises wet winding with at least one thermoset matrix.

25. The method of claim 24, further comprising the step of curing said at least one thermoset matrix material.

26. The method of claim 25, wherein the curing step is performed as a single step after all wet winding steps have been performed.

27. The method of claim 25, wherein the curing step comprises a full or partial cure between each wet winding step.
